(19) United States
(12) Patent Application Publication
(10) Pub. No.: US 2015/0154631 A1
(43) Pub. Date: Jun. 4, 2015

(54) Advertisement Platform With Novel Cost Models

(71) Applicant: Dennoo Inc., Pal Alto, CA (US)

(72) Inventor: Shigeto Umeda, Palo Alto, CA (US)

(21) Appl. No.: 14/388,723

(22) PCT Filed: Apr. 17, 2013
(86) PCT No.: PCT/US2013/037018

§ 371 Date: Sep. 26, 2014

Related U.S. Application Data
(63) Continuation-in-part of application No. 13/698,037, filed on Feb. 28, 2013.
Application No. 13/698,037 is a continuation-in-part of application No. 13/653,394, filed on Oct. 16, 2012.
Application No. 13/653,394 is a continuation-in-part of application No. 13/609,146, filed on Sep. 10, 2012.
Application No. 13/609,146 is a continuation-in-part of application No. 13/605,915, filed on Sep. 6, 2012.
Application No. 13/605,915 is a continuation-in-part of application No. 13/570,831, filed on Aug. 9, 2012.
Application No. 13/570,831 is a continuation-in-part of application No. 13/540,538, filed on Jul. 2, 2012.
Application No. 13/540,538 is a continuation-in-part of application No. 13/540,528, filed on Jul. 2, 2012.
Application No. 13/540,528 is a continuation-in-part of application No. 13/478,020, filed on May 22, 2012.
Application No. 13/478,020 is a continuation-in-part of application No. 13/477,981, filed on May 22, 2012.
Application No. 13/477,981 is a continuation-in-part of application No. PCT/US2013/031792, filed on Mar. 14, 2013.
(60) Provisional application No. 61/730,456, filed on Nov. 27, 2012.
(60) Provisional application No. 61/708,560, filed on Oct. 1, 2012.
(60) Provisional application No. 61/699,143, filed on Sep. 10, 2012.
(60) Provisional application No. 61/635,819, filed on Apr. 19, 2012.

(51) Int. Cl. G06Q 30/02

(52) U.S. Cl. CPC G06Q 30/0243

(57) ABSTRACT

Introduced is a method for presenting online advertisements. In one embodiment, the systems and methods described herein improve efficiency and efficacy of Internet based advertisements. Efficiency is improved by making advertisements relevant to the user, decreasing loss or waste in advertisement space and increasing opportunity for the publisher; and displaying advertisements only for an appropriate duration and charging advertisers according to the user's exposure to the displayed advertisement.

### CROSS-REFERENCE TO RELATED APPLICATION

This application claims the benefit of International Application No. PCT/2013/31792 filed Mar. 14, 2013, entitled “SYSTEMS AND METHODS FOR IMPLEMENTING AN ADVERTISEMENT PLATFORM WITH NOVEL COST MODELS”; U.S. patent application Ser. No. 13/698,037 filed Nov. 14, 2012, entitled “ADVERTISEMENT DISPLAY UI AND ADVERTISEMENT SYSTEM”; U.S. patent application Ser. No. 13/653,394 filed Oct. 16, 2012, entitled “METHOD AND SYSTEM FOR SERVING ADVERTISEMENTS BASED ON VISIBILITY OF AD-FRAMES”; U.S. patent application Ser. No. 13/609,146 filed on Sep. 10, 2012, entitled “METHODS AND SYSTEMS FOR BIDDING AND ACQUIRING ADVERTISEMENT IMPRESSIONS”; U.S. patent application Ser. No. 13/605,915 filed on Sep. 6, 2012, entitled “METHODS AND SYSTEMS FOR ACQUIRING ADVERTISEMENT IMPRESSIONS”; U.S. patent application Ser. No. 13/570,831 filed on Aug. 9, 2012, entitled “METHODS AND SYSTEMS FOR TIME-VARIABLE CPS BASED ON USER INTERACTION WITH ADVERTISEMENT”; U.S. patent application Ser. No. 13/540,528 filed on Jul. 2, 2012, entitled “METHODS AND SYSTEMS FOR AN INTEGRATED AD CAMPAIGN IN SOCIAL MEDIA”; U.S. patent application Ser. No. 13/540,538 filed on Jul. 2, 2012, entitled “METHODS AND SYSTEMS FOR TRACKING AD RELEVANCY USING USER INTERACTION”; U.S. patent application Ser. No. 13/477,981 filed on May 22, 2012, entitled “METHODS AND SYSTEMS FOR PROCESSING AND DISPLAYING ADVERTISEMENTS OF VARIABLE LENGTHS”; U.S. patent application Ser. No. 13/478,020 filed on May 22, 2012, entitled “METHODS AND SYSTEMS FOR BIDDING AND DISPLAYING ADVERTISEMENTS UTILIZING VARIOUS COST MODELS”; 61/635,819, filed Apr. 19, 2012, entitled “METHODS AND SYSTEMS FOR AN INTEGRATED AD PLATFORM TO BID AND DISPLAY ADVERTISEMENT OF VARIABLE LENGTH”; 61/699,143, filed Sep. 10, 2012, entitled “ADVERTISING PLATFORM”; 61/708,560, filed Oct. 1, 2012, entitled “METHODS AND SYSTEMS FOR MEASURING EFFECTIVENESS OF A USER CLICK TO AN ADVERTISER”; 61/730,456, filed Nov. 27, 2012, entitled “METHODS AND SYSTEMS FOR MEASURING EFFECTIVENESS OF A USER CLICK TO AN ADVERTISER”; and all of which are incorporated herein by reference for all purposes in their entirety.

### FIELD

The present invention generally relates to methods and systems for processing and displaying advertisements. Such processing and displaying an advertisement may include, for example, determining ad spots that are visible or at least a substantial portion of the ad spots that are visible for a pre-defined duration, and serving advertisements in those ad spots.

### BACKGROUND

Advertising in the field of e-commerce comprises several different types and modes of advertising, such as, for example, search based advertising, branding advertising, etc. One of two main types of advertising mechanisms or e-commerce based advertisements is the “Direct Response Advertisement,” such as Cost-Per-Click (CPC) in which cost accrues for clicks, or Cost-per-Action (CPA) in which cost accrues in the event of a particular action or conversion. The other major type of e-commerce based advertisement is “branding advertisement” in which cost accrues not based on clicks, actions or effectiveness, but based on the number of “impressions,” usually in lots of one thousand impressions, or Cost-per-Mille (CPM). An online advertisement impression is a single appearance of an advertisement on a web page. Each time an advertisement loads onto a user's screen, the ad server may count that loading as one impression.

Typically, advertisements are purchased and sold on cost per impression basis, regardless on which ad spot/slot/frame the advertisements are displayed to the end user. However, not all ad spots deliver the same impact or effect on advertisement. Some of the ad spots may not even be in the visible area of the web page. For example, an ad spot may be in bottom of the web page, which is outside the initial viewable area and is visible only when the user scrolls down to the bottom of the web page. Such ad impressions may not be effective since the ads may not even be viewed by the users. However, the advertisers are still charged for the impressions delivered. Accordingly, not all the ad impressions return the same return on investment (ROI).

Further, in the world of internet and e-commerce, advertisements may be displayed to the users over and over regardless of whether or not the user feels that an advertisement is interesting, relevant and engaging to them. That is, current advertising systems deliver ads regardless of whether or not they are effective. Such techniques do not fetch a good ROI for the advertiser.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 provides a brief, general description of a representative environment in which the invention can be implemented;

FIG. 2 is a block diagram illustrating an exemplary architecture of a platform server;

FIG. 3 provides a brief, general description of a representative environment in which an embodiment of the invention can be implemented;

FIG. 4A is a block diagram illustrating a system for presenting advertisement spots to an auction;

FIG. 4B provides an illustrative sequence of actions performed by the publisher, the web browser, and the SSP to identify the ad spots that are possibly visible to the user;

FIG. 4C provides an example of a webpage with ad slot that is monitored by zones around the ad slot;

FIG. 4D provides an example of a website being viewed by a user with web browser;

FIG. 5 is a flow diagram of a process for presenting ad spots to an auction;

FIG. 6 is a flow diagram of a process for measuring effectiveness of an ad creative;

FIG. 7 is a block diagram illustrating the measurement of a user's attention to various content areas displayed across a web page;

FIGS. 8A and 8B is a flow chart of a method that can be utilized by the system to measure viewable time for an ad content displayed in a given impression on a given web page;

FIG. 8C provides a flow chart of a method that can utilized to measure Owned Media Viewable Time (OMVT);

FIG. 9A illustrates the various ad ecosystem participants in a general environment the user is interacting with when the user is online;

FIG. 9B illustrates the interaction between the various participants when the pricing models are implemented by the third party ad server;

FIG. 9C illustrates the interaction between the various participants when the pricing models are implemented by the SSP;

FIG. 9D illustrates the interaction between the various participants when the pricing models are implemented by the DSP;

FIG. 10A provides a method that can be utilized by an ad platform to implement ad delivery based on an ad delivery scheme incorporating ad targeting and frequency limit (for view-throughs);

FIG. 10B provides a method that can be utilized by an ad platform to estimate ad relevance score for a given ad;

FIG. 10C illustrates the distribution of ads implementing viewed-through distribution and random distribution;

FIG. 11A illustrates the interaction between the various participants of the ad ecosystem when the ad targeting scheme is implemented by the third party ad server;

FIG. 11B illustrates the interaction between the various participants when the ad targeting scheme is implemented by the DSP;

FIG. 11C illustrates the interaction between the various participants when the DSP, implementing the ad targeting scheme, returns a bid to the SSP with bid amount that is lower than the reserve price the publisher is willing to accept to display the ad from the DSPs;

FIG. 11D provides a method that can be utilized by an SSP to manage ad delivery in response to an ad tag request from a client when the received bid amounts from the DSPs is lower than the reserve price the publisher is willing to accept to display the ad from the DSPs;

FIG. 12A provides a comparison between GRP of TV ad campaign and the eGRP of an online ad campaign;

FIG. 12B provides a general overview of a system that can be used to estimate the eGRP achieved by an ad campaign;

FIG. 12C provides a general overview of a system that can be used to predict an eGRP that can be achieved for a given ad spend;

FIG. 12D provides an illustrative method that can be utilized to estimate eGRP achieved by an ad campaign;

FIG. 12E provides an illustrative method that can be utilized to predict possible eGRP that can achieved for an ad campaign based on a given bid amount;

FIG. 12F provides a method that can be utilized to determine the cost for achieving a desired eGRP for an ad campaign;

FIG. 12G provides examples of computed eGRP based on various parameters described above;

FIG. 12H provides an illustrative example of the interactions between the various participants for assessing eGRP in one embodiment of a system used to assess eGRP;

FIG. 12I provides an illustrative example of a User Interface (UI), displayed on the computing system, which can be used by advertisers or ad agencies to interact with the computing server to estimate or calculate eGRP;

FIG. 12J provides an illustrative example of a UI, displayed on the computing system, which can used by advertisers or ad agencies to interact with the computing server to estimate or calculate eGRP;

FIG. 12K provides an illustrative example of the interactions between the various participants, in one embodiment of a system, for determining the cost for achieving a desired eGRP for an ad campaign;

FIG. 12L provides an illustrative example of a UI, displayed on the computing system, which can be used by advertisers or ad agencies to interact with the computing server to estimate the cost (or bid amount) to achieve a desired eGRP

FIG. 13 is a high-level block diagram showing an example of the architecture for a computer system.

The headings provided herein are for convenience only and do not necessarily affect the scope or meaning of the claimed invention.

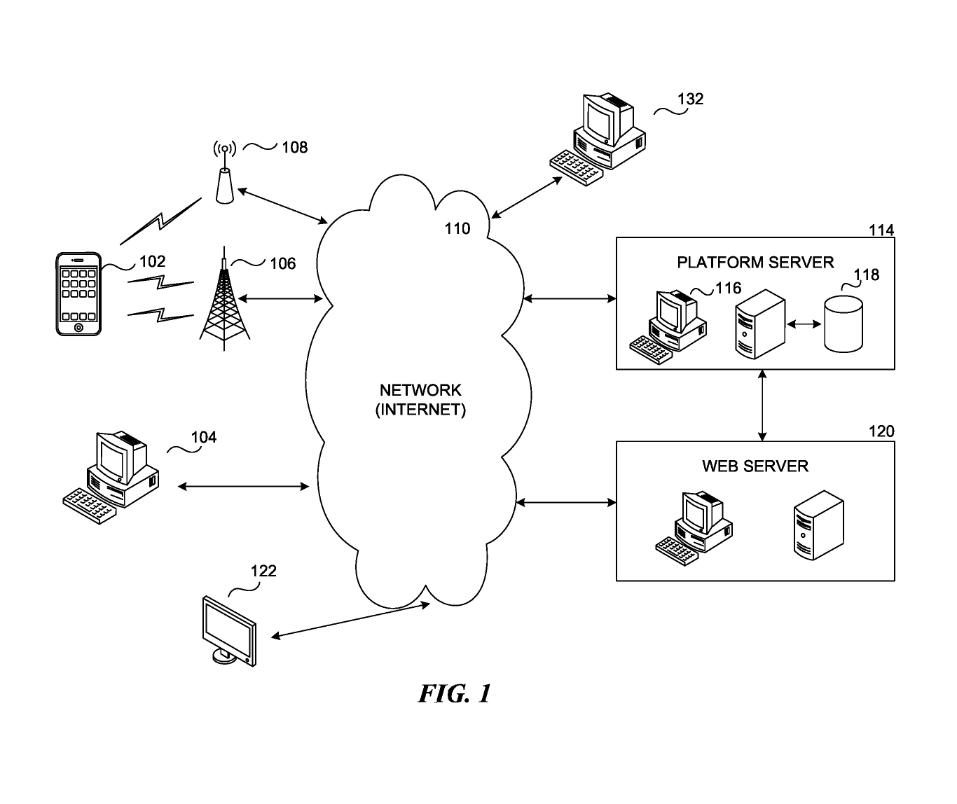

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 114 is first introduced and discussed with respect to FIG. 1).

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section. Note that references in this specification to “an embodiment,” “one embodiment,” or the like mean that the particular feature, structure, or characteristic being described is included in at least one embodiment of the present invention. Occurrences of such phrases in this specification do not necessarily all refer to the same embodiment.

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network and/or view displays communicated via the network 110. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments). In some instances, one or more users may also use an electronic display 132 (e.g., an electronic overhead display, an electronic billboard display, etc.) to view information communicated via the network. In the context of this description, information communicated may include, for example, advertisements displayed either by themselves or advertisements displayed in conjunction with web pages or other online media a user may be watching/experiencing. Concepts behind display of such advertisements will be explained in further detail in the following sections.

In some instances, the network 110 is the Internet, allowing the phone 102 (with, for example, WiFi capability), the personal computer 104, or the electronic display 122 to access content offered via various servers (e.g., web server 120) connected via the network. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

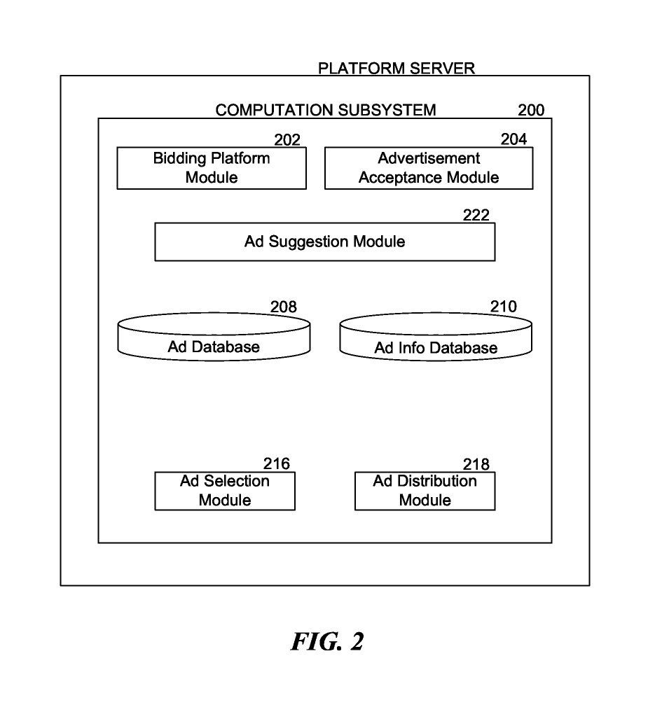

In some instances, a user uses one of the computing devices (e.g., the phone 102, the personal computer 104, etc.) to connect to a platform server 114 through the network 110. In one embodiment, the platform server 114 comprises a server computer 116 coupled to a local database 118. The term “platform server” as indicated herein, refers to an individual or multiple server stations or other computing apparatus. In one embodiment, the platform server is a web server capable of hosting a website and storing content (e.g., various webpages) that is associated with the website. In some embodiments, the platform server is separate from a web server, but communicates with a web server to provide, manage, and/or control content generated by the web server. In general, the platform server 114 includes various modules (either implemented as software or in hardware) that allow for advertising information to be collected from advertisers wishing to strategically engage in an advertising campaign, and to coordinate and relay ensuing advertisements to end systems. In embodiments, the platform server may independently coordinate the processing and eventual display of advertisements. In embodiments, as will be explained in the example of FIG. 2, the platform server may offer interfaces (e.g., APIs) to existing advertising network platforms to coordinate one or more specific advertising activities (e.g., providing abilities for bidding, providing campaign conversion modules, etc.) as will be explained in further detail below. As will also be explained in further detail herein, the administration server 114 incorporates one or more functional units to achieve each of the above discussed functionalities.

As shown in FIG. 1, in some embodiments, the personal computing devices and the administration server 114 are connected through the network 110 to one or more web servers (e.g., web server 120). Each web server corresponds to a computing station that enables a website provider, for example, to provide web content (e.g., web pages) that can be accessed by the personal computing devices through the network 110.

An platform server, as defined herein, could be a separate server offering the service described herein to, for example, one or more website providers. In other examples, the administration server could by itself be a website provider that also runs a service that accomplishes the techniques described herein. Additional examples of implementing an administration server, as understood by a person of ordinary skill in the art, are equally suitable for implementing the techniques described herein.

In the context of the systems described herein, in one embodiment, the platform server is implemented as a search system that enables advertisement display measures, allowing one or more advertisements to be shown either simultaneously or at various discrete timings based on advertisement data obtained through the network (e.g., from an advertising client 132). The platform server 114 may then communicate the advertisement to an advertisement display system (e.g., the user's personal computing device) in which the individual advertisements are shown for a predetermined length of time or according to variables established by the advertising client.

Consider an exemplary scenario where distinct advertisements x1, x2, x3, . . . xp are to be shown to the user as processed and output by the platform server 114. These advertisements are predetermined to be displayed for lengths of t1, t2, t3, . . . tp. However, this does mean that that the advertisement to be shown is also predetermined. For example, if a user browses and views the internet using a PC, various advertisements may be shown for various situations, and the techniques described herein includes the case in which these advertisements are shown and sustained for a predetermined length of time.

An advertisement, as described herein, includes without limitation movies, still images, banners, animated pictures, etc. As processed by the platform server, such advertisements are shown for a period and such periods may be predetermined, for example, by the advertiser. In cases where the advertisement is a movie, either the length of the prepared movie or the play time designated by the advertiser will be the display time for the advertisement. In cases where the advertisement is a still image, the display time will be the time designated by the advertiser.

The “display” of an advertisement refers to display of an advertisement that can be substantial or meaningful. For example, on a web screen, if the user scrolls down on the screen, it is preferable that the advertisement scrolls alongside to fit the screen on which it is displayed. However, if the above method is not possible and the user scrolls the screen to the extent that the advertisement is no longer visible on the screen displayed, the advertisement should be stopped, and the time that the advertisement had been played should be recorded (at least for the purpose of computing cost per second of display of the advertisement, as will be explained further below). When the advertisement returns to display on the screen, the advertisement should be resumed, and the total playing time will be recorded at the end of the advertisement or at the time of the next stop.

The judgment of “whether the advertisement is displayed or not” can, for example, be that if a certain proportion of the advertisement is not shown within the screen, the advertisement can be considered to be “not displayed on the screen”. Here, a “certain proportion” can refer to a proportion at which substantial viewing of the advertisement can be deemed to be difficult, for example at a proportion of 50% or more. However, more than 50% is merely an example, and the proportion need not be limited to 50% or more. For example, the advertisement display can be divided into a major portion (e.g. the portion where the product or service name to be advertised is shown) and a minor portion, and when the major portion is shown on the screen, it may be judged that the advertisement is displayed on the screen.

The techniques discussed herein include a bidding system that allows an advertiser to place a bid for a certain spot and duration of advertisement. As illustrated with respect to FIG. 2, the platform server 114, in some embodiments, may include a bidding platform module 202 to enable the bidding operations. In the way of an example, the bidding platform module may present an appropriate GUI to the advertising client 132 to enable the advertiser to make appropriate selections and provide input. These are then taken in by the bidding platform module 202 for further processing and assessing for bidding.

In situations where the advertiser is aware of the display length beforehand, in embodiments, the advertiser may use bidding as the method of advertisement display time sales (“purchase” from the advertisers' perspective) in order to determine the order of precedence when displaying the advertisement(s). In other words, the amount of advertisement that can be displayed within an advertising space is generally finite. In addition, for web screens, if there is more than one advertisement that can be shown on the same advertisement space, the order in which the advertisements are placed becomes important. Specifically, when displaying advertisements on a specific advertisement space or for specific keywords, an input is made (e.g., in the form of a bid) for the maximum cost/price that the advertiser can bear for that particular combination of duration and order. It is evident that the order or precedence will be higher when this cost/price is higher.

### Cost Per Second (CPS) Based Technology

In at least some embodiments as disclosed herein, the length of time that an advertisement will be shown will vary not only according to the advertisement itself, but also according to secondary factors (e.g., keywords, search relevance, etc.). For example, when publishing an advertisement on a search result page, conventionally, bids are placed for a certain keyword A, and the advertisement to be displayed with higher priority is determined and fixed according to this price. On the other hand, for this invention, comparisons are not made according to the price per display (or impression) of an advertisement, but by the bid on the price per unit of time, or Cost per Second (CPS). Bids can be placed directly through CPS, or the cost per advertisement can be used as the unit of bid, and divided by the number of seconds of advertisement display in order to calculate the CPS to compare prices between various advertisements.

For example, assume that there exist two advertisement spaces (F1 and F2) on a search result page for a certain keyword A, and that the advertisement effect of advertisement space F1 excels that of advertisement space F2. If advertiser D1 bids for price P1, advertiser D2 bids for price P2, advertiser D3 bids for price P3 and P1>P2>P3, conventionally, advertiser D1 won advertisement space F1, advertiser D2 won advertisement space F2 and advertiser D3 could not win an advertisement space. As a result, the publisher/media can only utilize two advertisement spaces (and lose revenue from advertiser D3), and advertiser D3 would lose the opportunity to advertise.

However, using technology introduced herein, for example, the publisher/media can sell the two advertisement spaces (F1 and F2) separately at the time of the bid. For example, for advertisement space F1, advertiser D1 bids for a CPS price P1, advertiser D2 bids for a CPS price P2, advertiser D3 bids for a CPS price P3 and P1>P2>P3, the advertisement display time for F1 can be sold to advertiser D1, advertiser D2 and advertiser D3 in the respective order.

Additionally, if the total time that the advertisements are played for each advertisers D1, D2 and D3 are T1, T2 and T3, respectively, in simple terms, the publisher/media receives an advertising revenue of P1×T1+P2×T2+P3×T3 (in reality, if the displayable time exceeds T1+T2+T3, the order of priority will be determined as D1>D2>D3. Additionally, the order of priority can be changed according to other factors such as the time in the day, etc.). As a result, the publisher/media can utilize their advertisement space with higher efficiency, and each advertiser will be able to display advertisements with higher efficacy. In other words, if each advertisers' advertisement (assuming that each had one type of advertisement) has a display length of t1, t2 and t3 per advertisement, each advertiser will be able to publish T1/t1, T2/t2 and T3/t3 advertisements respectively (assuming that there is no upper limit to the display time). For the user, the amount of information received would be greater than the conventional cases in which one advertisement is shown repeatedly. However, it should be noted that the above example is a highly simplified version. Alternately, a better system may be one that incorporates a display method in which the price determination method is consistent with that in the conventional market.

As offered by the CPS technology introduced herein, the advertisement billing is based on CPS×Seconds Displayed. In embodiments, the cost charged to the advertiser is based on the actual display time. This is because the purchase of the advertisement space is not for an entire unit based of a single display, but for the price/cost per second of an advertisement that will be shown only for a certain time length. The “actual display time” should ideally be the “time that the user is actually watching.” The actual display time may be measured using techniques as understood by people of ordinary skill in the art at the time of this application. However, in systems where constraints are present due to, for example, cost and facilities, the realistic time measurement used can be the “time that the advertisement is shown on the screen”. In other words, the advertisement display time will be measured as the “period in which the advertisement is displayed on the screen”.

Illustration of Ecosystem Utilizing CPS Scheme within Conventional Market

The following section discloses the CPS based advertising platform, where various types of bidding schemes, including bidding schemes based on conventional parameters may be accepted and conversion schema applied to allow for interoperability. When the advertiser is bidding by CPM, the system disclosed herein converts this bid into CPS. In conventional systems, if an advertiser bids by CPM, the price per 1000 page views was constant regardless of the number of clicks. In the system devised by this invention, advertisement slots are not sold by page views (PVs). In the CPS methodology, the entire user session becomes a single unit ad slot, dissected finely into seconds. Sessions are tailored to the exact needs of advertisers. Page views no longer matter, and the flexibility, efficiency and effectiveness of advertisements improve significantly. When using advertisements of variable lengths such as those devised by the techniques described herein, the switching of advertisements are based not on page transition but on time.

Media publishers generally request ad placement requests through Ad networks. In the conventional internet ad market, the ad slot inventory is sold in units of page views, where the advertisers, for e.g., pay eCPM per page view. In order to enable CPS based advertisement platform to work with the conventional platform, the page view market needs to be converted to sessions. In this embodiment, the session length is estimated based on previously achieved average viewable time (AVT) for a given ad inventory. By placing monitoring tags in each of the publisher's media, the Ad network and in turn a DSP (or any other participants of the ad ecosystem) can monitor both the number of page views and a total user engagement time measured for previously placed ads to compute the AVT.

Here, AVT, or the average viewable time is defined as the sum of all ad view lengths (AVL) on the media (i.e. total user engagement time measured for previously placed ads on the media) divided by the total number of page views (PV) on the media. The equation for AVT measurement is below in eq. 31:

$$AVT = \frac{\sum AVL}{PV} \qquad ( 31 )$$

Based on the above equations, eCPS may also be written as shown below in eq. 32:

$$eCPS = eCPM \times \frac{AVL}{AAL} \qquad ( 32 )$$

With the above equations, accordingly, eCPM value may then be converted to an eCPS value. As described above, based on the AVT, DSP can now compute the eCPS for the media requesting ad placement. Using the conventional eCPM valuation and the DSP computed eCPS ad valuation, DSP can identify media publishers who are undervalued in the current ad market. Media publishers who have a lower eCPM than eCPS can thus expect better valuation by treating ad slots as CPS based sessions instead of conventional page views based scheme.

Accordingly, in embodiments, advertisements are shown for a certain periods of time. In other words, the advertisements displayed will have a designated order or priority, and more than one advertisement may be shown continuously in a loop. The order, precedence, and length of running such advertisements may be based on a variety of factors. Such factors may be accounted for, for example, through the bidding platform offered in conjunction with the platform server. An example of such a factor may be an order of priority (e.g. time of the day). When such a factor is introduced, it is not known under which conditions the advertisement should be displayed for higher effectiveness. One way to overcome this issue would be to play the advertisements in varying orders with equal likeliness. When this is the case, a statistically significant sample size will be chosen, and various orders will be tested for this sample. The index when evaluating the effectiveness can be, for example, Seconds per Click (SPC), or the number of seconds necessary until the user clicks the advertisement. Analyzing that information over, for example, the time of day such events occur, statistical information may be collected to determine order of priority and corresponding bid value for placing advertisements on the web screens. Using these results, the advertisements can be shown in the order of this index.

The explanation illustrated an example of a case in which advertisements are shown on a search result page, but it is understood that the techniques discussed herein may be applied to a variety of other advertisement types as well. For example, the techniques introduced herein include a novel online advertisement concept where direct response advertisement and branding advertisement are both combined (the product of the two is taken). Correspondingly, there are two main types of advertisement sales: (1) the CPS (cost per second) mode of advertisement sales (as discussed above); and (2) the product of CPS and Cost per Click (CPC), which would be CPS×CPC. CPS is the price per second of advertisement display, and CPC is the cost that the advertiser bears when a user clicks on an advertisement while watching an advertisement and jumps to a website designated by the advertiser. In order to determine the order of priority of advertisement display, the prices of advertisements (e.g., as placed in bid values) are compared, but in an exemplary scenario, a value in which both the CPS and the CPC are included may also be considered in assessing relevance and priority of the bidders. As indicated here, N=CPS×CPC may be a simple case for accounting the CPS and CPC elements jointly, but it is understood that other conversion formulas where the two elements may be effectively considered may also be used.

In embodiments, the platform server 114 includes logic for the purposes of determination of the two types of cost determination and to identify targets and correlation between the two types. In embodiments, and as illustrated in FIG. 2, the platform server may include one or more of the following modules, each being implemented either in hardware, software, or firmware, or a combination thereof: an advertisement (or ad) suggestion module 222 to make determinations and provide according suggestions as to the type, content, duration, etc. of advertisements to be placed on various publishers' sites. The logic incorporated in this module may include, for example, algorithms to identify significance, meaning, context, relevance, etc. of a particular website and accordingly identify relevant advertisements. Further, the platform server 114 may include an advertisement accepting means 204 for accepting advertisements uploaded by advertising clients 132. In embodiments, the platform server 114 may also include advertisement memory 208 for storing advertisements received from advertisers and advertisement information memory 210 for storing information related to advertisements (e.g., relevance information, order or priority information, etc.). In some instances, the modules may further include an ad selection module 216 and an ad distribution module 218 that are configured respectively to select an appropriate ad and to transmit the ad to a predetermined web screen based on determinations made by the platform server.

In embodiments, these include means that are accessible online by the advertiser. Each component/module identified above may be implemented as discrete software or hardware units or a combination thereof. In embodiments, for example, the advertisement space suggestion module to suggest advertisements for publishing on advertisements spaces and the advertisement bidding means can be combined into or be coupled to a web server 120. In embodiments, the structure of the platform may include, for example (in the case of displaying advertisements in a search result page), a GUI to suggest a page in which the keywords used for the search, the various attributes of the user to which the advertisement is desired to be displayed (gender, age, region, profession, educational background, hobbies, etc), the preferred time of the day to display the advertisement can be entered, etc. According to these entered inputs, the price per unit of time for purchasing the advertisement space and the entry field for purchasing the advertisement space (or an entry page) will be then be displayed. For the suggested advertisement space, the advertiser inputs (e.g., through the bidding platform) the desired price per unit of time to purchase the advertisement space, and the number of advertisement spaces to purchase. However, in embodiments, the purchasing of advertisement space can be for the total length of time that the advertisement will be displayed.

In embodiments, the advertisement information memory 210 and the advertisement data memory 212 to store the advertisement itself may include, for example, advertisement information database means to store information related to the advertisement and an advertisement data database means respectively to store the advertisement itself.

Returning back to the illustration of FIG. 1, the process of utilizing the platform server to process and display advertisements is now explained with respect to two scenarios: (1) when the advertisement is returned to a user viewing the advertisement in a web screen; (2) when the advertisement is displayed to multiple users over an electronic display instrument (e.g., an electronic bill board).

As illustrated in FIG. 1, when the advertiser accesses the bidding platform module of the platform server 114, the system, for example, suggests an entry field for the desired conditions regarding the advertisement display. The advertiser 132 inputs the desired conditions accordingly. In response, the platform server 114 may request entry of an advertisement. The received advertisement and advertisement information is then stored in the advertisement video database and the advertisement information database by the advertisement reception device. In embodiments, the information stored in the advertisement video database and the information stored in the advertisement information database are related and attributed by an advertisement ID that is unique to each advertisement. In embodiments, when the advertisement information is transmitted to a display device, the related information may also be attributed by the advertisement ID.

In the first scenario, the user typically has an advertisement display device that is loaded into the web browser (e.g., a widget within a web page, etc.). At this time, in order to display advertisements that match the user's interests, information regarding the page shown and user IDs are sent to the advertisement selection device of the platform server. An advertisement selection module 216 selects the advertisement(s) to be displayed based on the received information and the advertisement data stored in the advertisement information database. The advertisement selection module 216 selects the advertisements to be shown, and the advertisement ID of the advertisement to be shown will be sent to the advertisement screening device (e.g., the user's computer).

After receiving one or more advertisement IDs from the advertisement selection module 216, the advertisement transmitting or distribution module 218 sends one or more advertisements continuously to the advertisement display device. The advertisement screening device displays the advertisement to the user upon reception. For videos, the display time is generally determined by the length that the video advertisement is played. For still images, the display time is determined by the time designated by the advertiser.

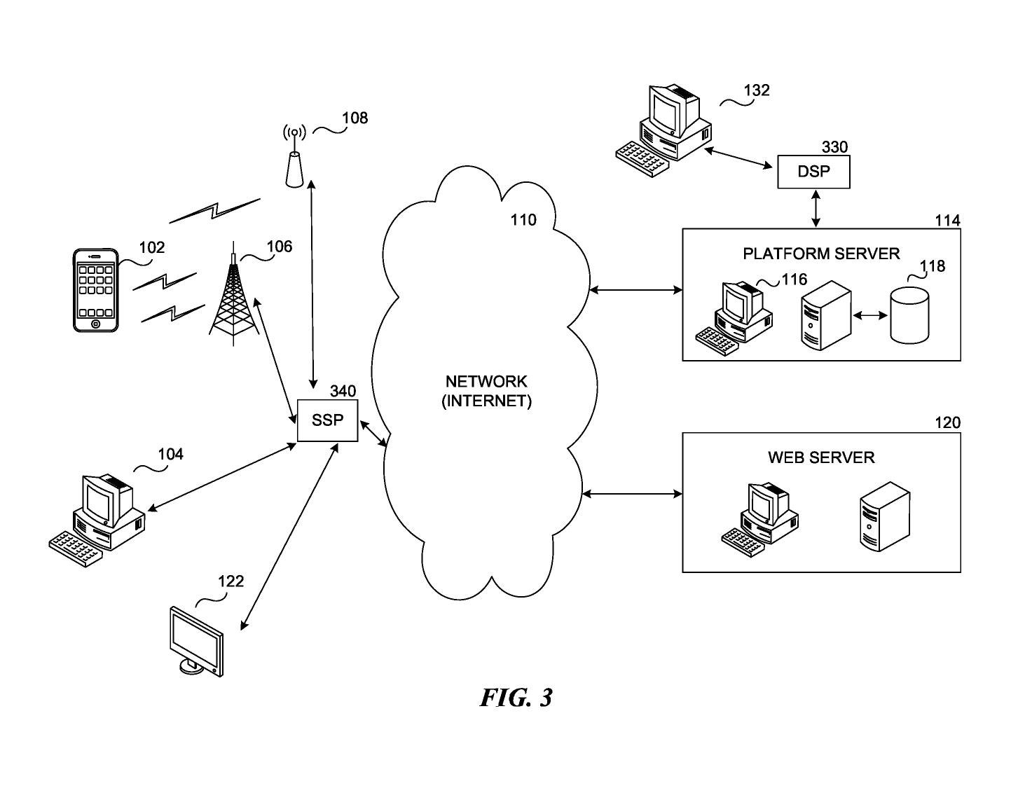

FIG. 3 illustrates the second scenario, where the advertisement display device with which the user watches advertisements is not equipped on the browser, but rather a device that is connected to the internet, such as on an LCD display for street advertising (e.g., device 122). In this scenario, the advertisement display device is not equipped on a web browser, so information as to the basis of selecting the advertisement to display may not exist. In such cases, the advertisement display device does not send out information for advertisement selection, but instead just display the advertisements continuously in a predetermined order. However, for example, if a digital signage device is located in various stores and locations, it is possible that conditions for selecting the advertisement, such as showing it on a device in a ramen noodle store in the shopping quarters from 5 PM to 11 PM, are specified and the advertisements are shown accordingly. In such cases, the advertisement that best matches such conditions may be selected. For videos, the display time is generally determined by the length that the video advertisement is played. For still images, the display time is determined by the time designated by the advertiser

A third scenario of processing and displaying advertisements in accordance with the techniques discussed herein is illustrated with reference to FIG. 3. In this example, the publishing of advertisements and the displaying on the advertisement viewing device are carried out not directly between the advertiser and the user, but by using interfaces to a Demand Side Platform (DSP) 330 and a Supply Side Platform (SSP) 340. The composition of this exemplary embodiment constitutes an advertisement exchange that can incorporate the present teachings with conventional advertising exchanges.

In embodiments, either the DSP, SSP or both may be included. The composition can be either through a connection with the DSP, a composition with a direct connection to the advertiser, or a combination thereof. Similarly, the composition can be either through a connection with the SSP, a composition with a direct connection to the user, or a combination. Other similar combinations of one or more DSPs and SSPs, as may be contemplated by a person of ordinary skill in the art, may also be used as alternate or variants of the above discussed composition.

In this example, when the advertisement is sent by the advertiser, it is stored in the DSP, which acts as the mediator on the advertiser's side. The DSP then selects an advertisement exchange (not shown) from among the advertisement exchanges, and the advertisement is published. In order for the device devised by this invention to receive the advertisement, a bid to determine the price of the advertisement is received from the advertiser through the DSP.

On the other hand, on the user's side, the advertisement is received not directly from the device devised by this advertisement, but from the SSP, and the advertisement is shown. After receiving the advertisement display request from the user, the SSP selects one or more advertisement exchanges to receive advertisements from, and requests for advertisements. At this time, the system (advertisement exchange) devised by this invention, which has received the advertisement request, also receives information necessary to select the advertisement that best matches the user, and according to this information, chooses the best-match advertisement from the displayable advertisements, sending the advertisement to the SSP. After receiving the advertisement, the SSP sends the advertisement to the user, and the user watches the advertisement.

In embodiments, with such a composition, the advertising side can increase the effectiveness of their advertisement by widening the array of media/publishers to display their advertisements on. The results in quantifiable advantages on both sides of the spectrum—on the media/publisher side that will show advertisements, revenue for advertisement spaces increases by allowing for selection from a larger number of advertisements the advertisement that best matches the users' interests. From the users' perspective, for similar reasons, advertisements will be chosen from a greater variety, and the users will be able to watch advertisements that match the users' interests.

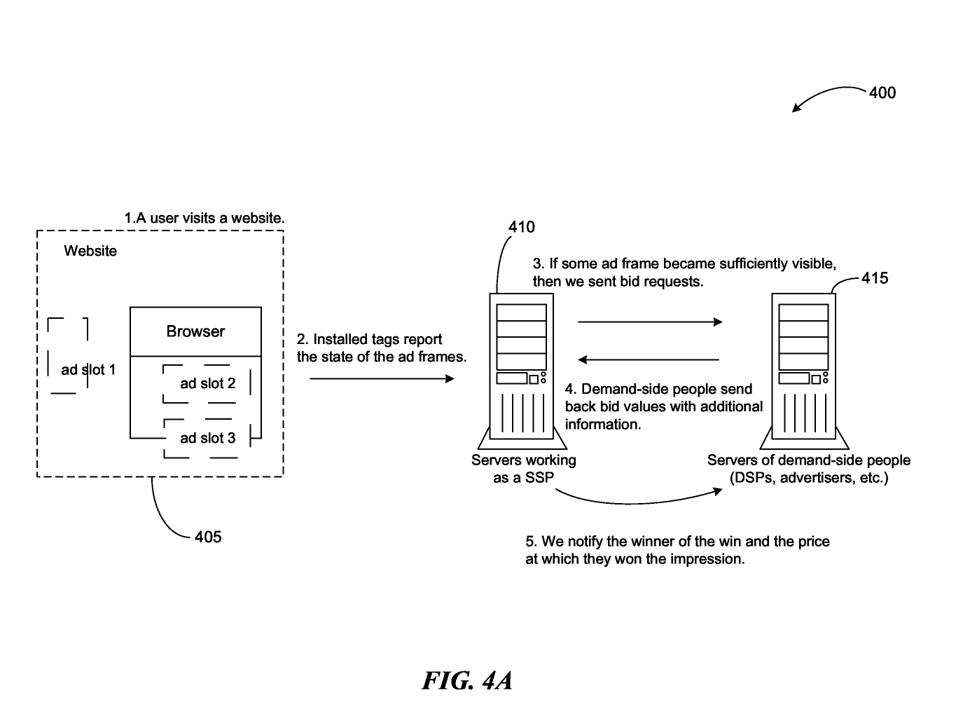

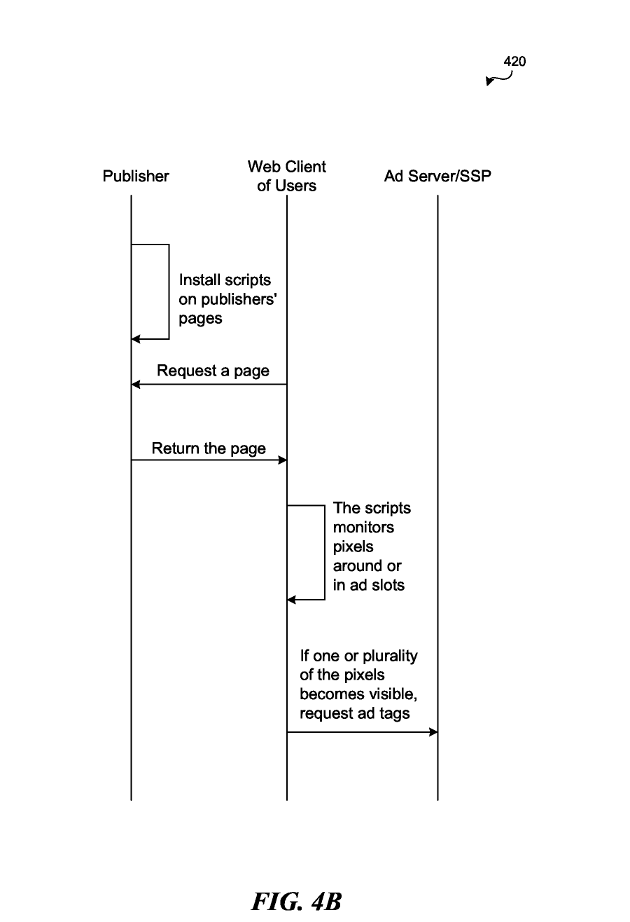

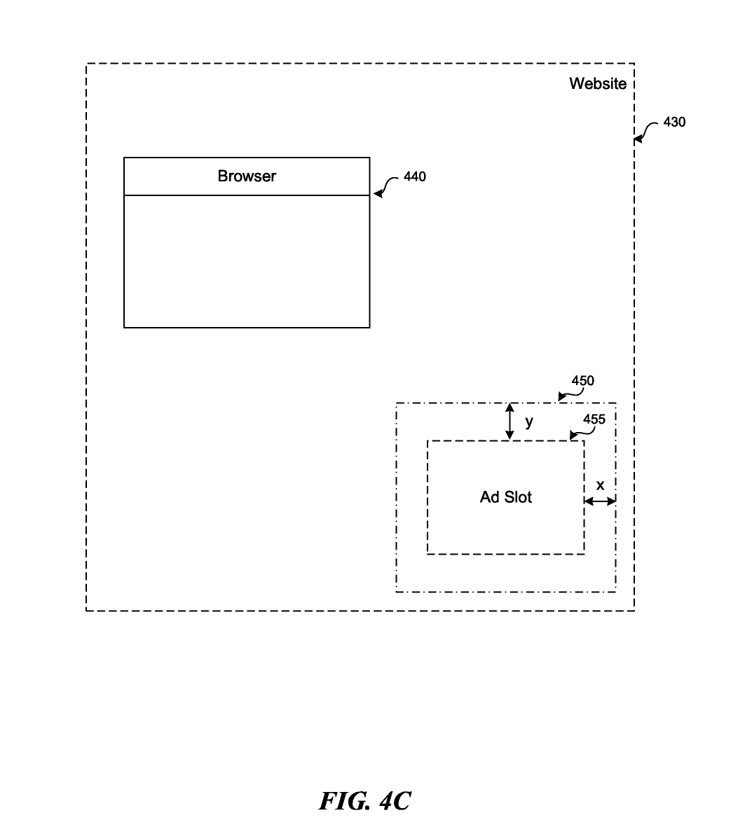

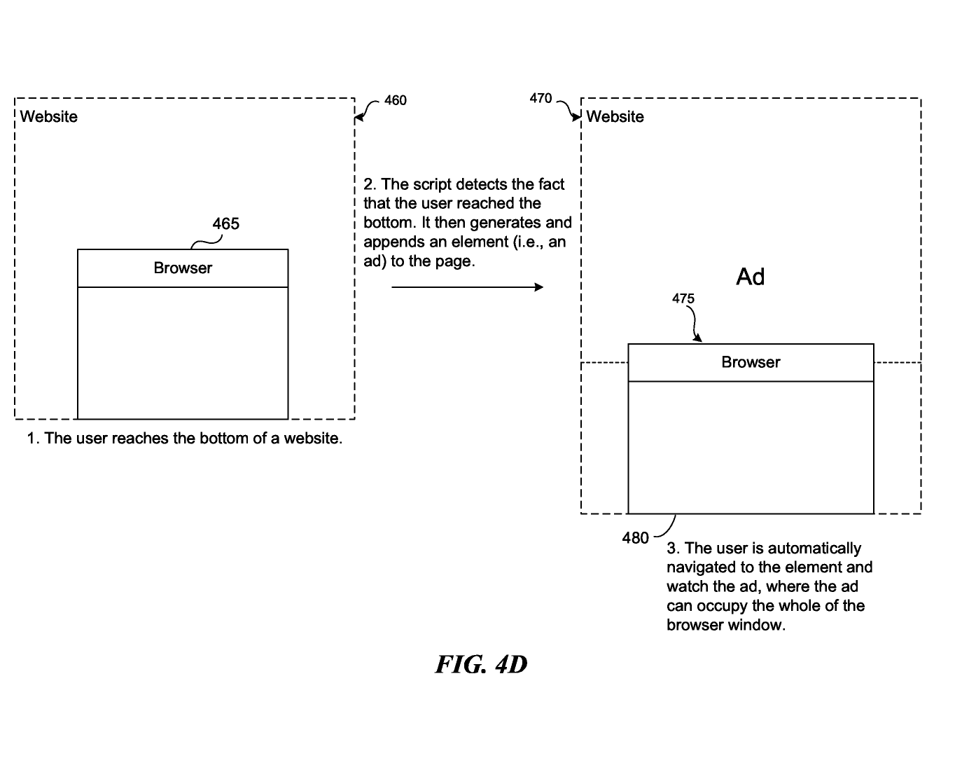

FIG. 4A is a block diagram illustrating a system 400 for presenting ad spots to an auction, according to an embodiment of the disclosed technique. The system 400 includes SSP 410 (similar to SSP 340 of FIG. 3) that identifies the ad spots on a web page 405 and presents them to an auction. The DSP 415 (similar to DSP 330 of FIG. 3), such as advertisers, participate in the auction by bidding for the ad spots. The web page 405 can include any online content that is accessible by a user through, for example, a web browser or any other proprietary applications. The web page 405 includes one or more ad spots and each of the ad spots can render one or more advertisements served by the SSP 410. A user accessing the web page 405 may view the advertisement rendered in the ad spots and perform an action on the advertisements.

The SSP 410 is configured to identify the ad spots that are visible to the user for a predefined duration, and present only those ad spots to the auction. In an embodiment, the SSP 410 identifies those ad spots for which a pre-defined portion of the ad spot, typically a substantial portion, is visible to the user. In an embodiment, the substantial portion could be at least 50% of the ad spot area and pre-defined duration can be at least 100 milliseconds. After the ad spots are determined, the SSP 410 presents the ad spots to the auction and requests the advertisers to place bids for the ad spots. The request may also include a response time indicating a time within which the advertisers have to submit their bids.

In an embodiment, the SSP 410 identifies the ad spots that are visible to the user using scripts that are pre-installed in the web page 405. The web page 405 includes various pre-installed scripts which monitor the web page 405 as it is being viewed by the user through the web browser. The scripts monitor if any of the one or more pixels around a given ad spots (also referred to as the “ad slots”) in the web page 405 become viewable to the user. The script, utilizing the web browser, reports that the ad spots are possibly visible to the user through a request for ad tags (which can be utilized to identify and request ad content as explained later) to SSP 410 (or an ad server).

In response to the bid request from the SSP 410, the advertisers/DSP 415 submits the bids along with the advertisements to be served in the ad spots, to the SSP 410. After receiving the bids from the advertisers, the SSP 410 determines a winning bid based on predefined criteria, such as second-bid auction process described in U.S. patent application Ser. No. 13/609,146, or any other convenient method. The SSP 410 notifies the advertiser regarding the winning price of the impression. Further, the advertisement of the winning advertiser is served in the ad spot. Accordingly, by serving ads in visible ad spots the chances of an ad not being viewed by a user is reduced.

FIG. 4B provides an illustrative sequence of actions performed by the publisher, the web browser, and the SSP 410 to identify the ad spots that are possibly visible to the user. Here, one or more scripts are installed on the publisher's webpage which can be utilized to monitor zones (e.g., zones defined by pixels) around ad slots on the webpage. When a web client of a user requests a webpage, such scripts can be included with the webpage provided to the web client, enabling monitoring of the user actions with respect to the webpage. When the scripts detect any portion of the monitored zone (e.g., one or more pixels of the monitored zone) become visible to the user, the web client is utilized to request ad tags from SSP 410, where the ad tags can be utilized to downloads advertisements that can be shown in the ad slot within the monitored zone.

FIG. 4C provides an example of a webpage 435 with ad slot 455 that is monitored by zones 450 around the ad slot 455. The script monitors the zone 450 around the ad slot 455 defined by the x and y width pixels around the ad slot 455. So, when the zone 450 around the ad slot 455 comes into view on the web browser 440, the monitoring script can inform the SSP 410 that the ad slot 455 is visible to the user. By monitoring such zones around ad slots, the true degree of visibility of an ad slot and in turn its true price can be assessed. For example, if an ad slot is at the bottom of a page, it seldom becomes visible and is usually low-priced. However, since the content of the page usually finishes at the bottom of it, the user's engagement would tend to shift from the content to the ad slot.

In this situation, the true value of this ad slot can be realized and generate higher revenue for the publishers. In some embodiments, the ad slots at the bottom of the page are only auctioned when the user's engagement is towards content at the bottom of the page. By doing so, the publisher of the webpage can demand a higher rate for the increased visibility of the ad slot to the user and still be able to achieve a higher realization even when the ad slot is only auctioned when the user's engagement is towards content at the bottom of the page (and not auctioning the ad slot at a lower rate when the visibility of the ad slot is little or nothing).

In some embodiments, elements (such as a video content) can be dynamically appended to web pages on occasion based on a user's action, by lapse of time, etc. For example, when a user scrolls on a hyperlink for a video, the video can be dynamically appended to the bottom of a currently loaded webpage on the user's web browser, where the user would either be automatically guided to the appended video or be required guided based on some user action. So, such dynamic appending can occur outside the region currently visible to the user. By utilizing monitoring zones in those appended elements, the effectiveness of any ad slots contained in the appended elements on these pages can be enhanced.

In some embodiments, the monitoring zones can be utilized to monitor portions of the webpage irrespective of the content in the monitored portion of the webpage and perform one of many possible actions when any portion of the monitored portion of the webpage becomes visible to the user. For example, a monitoring zone can be attached to the bottom of a webpage, such that when any pixel that falls within the monitoring zone becomes visible to the user, an ad slot can be dynamically appended to the bottom of the webpage, where the ad slot could completely occupy the newly appended portion of the webpage. The user can then seamlessly be attracted to watch any displayed advertisement in the newly appended ad slot.

In another example, the monitored zone can be embedded in the middle of the webpage. As the user scrolls the webpage and any portion of the monitored zone in the middle of the webpage becomes visible, an ad slot can be dynamically generated in a designated portion of the webpage (e.g., within the monitored zone) by replacing the content within the designated portion of the webpage. Here, the ad slot is not appended to the webpage. The webpage size remains the same. Instead, a portion of the content of the webpage can be dynamically altered to accommodate the new ad slot. The ad slot can be sold in an auction similar to the ad slots within the monitored zones. In some embodiments, the content altered can be unaltered (e.g., the missing portion of the content removed to accommodate the new ad slot) and returned to the original form in response to a user action, such as the user closing the newly created ad slot.

FIG. 4D provides an example of a webpage 460 (also referred to as the “website”) being viewed by a user with web browser 465. The webpage contains a monitoring zone (not shown in FIG. 4D) that monitors all the pixels at the bottom of the webpage 460. When the user scrolls the webpage 460 and the bottom pixels within the monitored zone become visible to the user through the web browser 465, 475, the web browser 475 is requested to load an ad slot 480 and append it to monitored zone, i.e. the bottom of the webpage 460, 470. The ad slot can be further auctioned to display advertisements using the various visible ad slot identifying methods discussed above.

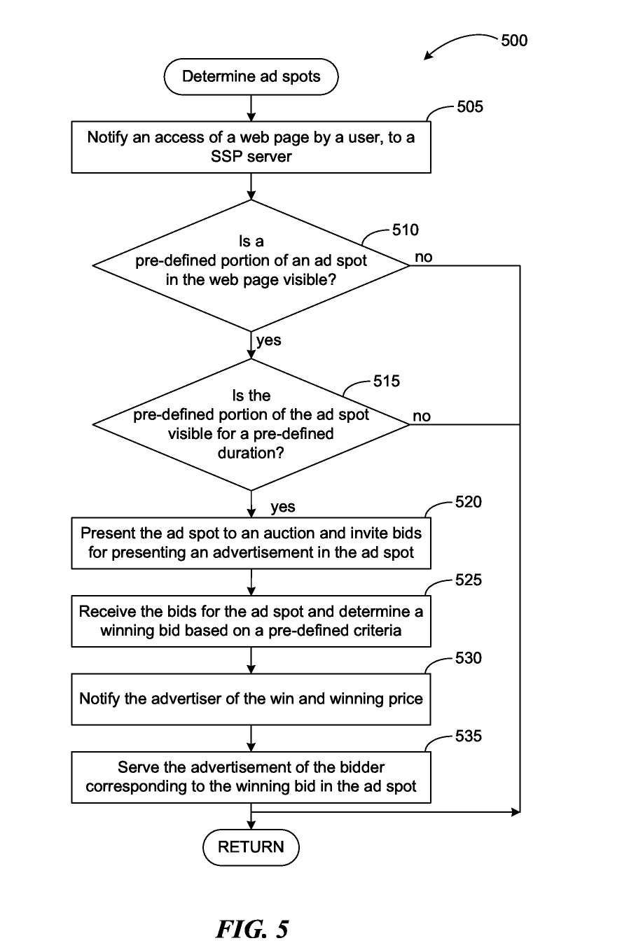

FIG. 5 is a flow diagram of a process 500 for presenting ad spots to an auction, according to an embodiment of the disclosed technique. The process 500 may be executed in a system such as system 400 of FIG. 4A. At step 505, SSP is notified of a user's visit to a web page. At determination step 510, the SSP determines whether a pre-defined portion (substantial portion) of an ad spot was visible. Responsive to a determination that the substantial portion of the ad spot was visible, at determination step 515, the SSP determines whether the substantial portion of the ad spot was visible for a predefined duration.

Responsive to a determination that the ad spot was visible for a predefined duration, at step 520, the SSP presents the ad spot to the advertisers/DSP server in auction and invites the advertisers to submit bids for the ad spot. At step 525, the SSP receives the bids from the advertisers and determines a winning bid based on predefined criteria. At step 530, the SSP notifies the advertiser of the win and the winning price. At step 535, the advertisement of the winning advertiser is served in the ad spot.

In an embodiment, the process 500 is executed for all the ad spots in the web page. Referring back to steps 505-515, a tag, such as an HTML tag, is embedded in the web page to capture data regarding the user's visit to the web page, visibility of the ad spots, the duration of visibility, etc. and send the data to the SSP.

Referring back to step 520, when the SSP sends the request to the advertisers to submit bids for the selected ad spots, the SSP also requests that the bids be placed within a pre-defined time limit, t_{b}. The SSP may specify the time limit to the advertisers either by including it in the request or by any other suitable way.

Referring back to step 525, the advertisers respond to the bid request, by submitting bid values along with additional information, such as the ad to be served in the ad spot if an advertiser wins the bid. Referring back to step 530, the winner and the price is determined using a second-bid auction method, or by other suitable methods.

### Measuring Effectiveness of an Advertisement Creative

A user can respond to an ad creative in a number of ways, for example, by rewinding an audio clip or video clip, enabling sound of the ad, pointing a cursor of a pointing device to a particular portion of the ad, clicking the ad, saving the ad, forwarding the ad via email to other users, sharing the ad with other users, etc. In an embodiment, an ad on which a user performed user action may be considered more effective than the ad on which the users did not perform any user action. Accordingly, the effectiveness of an ad may be measured using various actions performed by the user on the ad.

The effectiveness metric can help the advertisers in creating ad creatives that are more effective and thus, help in obtaining an improved ROI. In an embodiment, the effectiveness of an ad may be measured using an engagement rate of the ad, which summarizes users' overall responsiveness to an ad creative.

Assume, U denotes a set of unique users to whom ad creative c was delivered, and Vᵤ denotes the set of ad impressions that received a response by a user u, where uεU. Assume that each ad impression v, such that vεVᵤ, is viewable (as determined by process 500). Further, assume that A denotes a complete set of user response types, such as rewinds, altering sound, mouseover, clicks, saving the ad, forwarding the ad, sharing the ad, etc. A response score Sₐ, where 0<Sₐ (u,v)≦1 of action aεA, indicates a degree to which user u performed action a on an ad impression v.

Some example user actions and their response scores, (a, Sₐ) for a user u on an ad impression v of an ad creative c include the following:
Mouseover user action
   Sₐ(u, v)=1 If the user pointed a cursor of a pointing device, such as a mouse, over the ad impression for more than t seconds. Time t, is a configurable pre-defined value (for example, 3 seconds).
   Sₐ(u, v)=0, if the above condition is not satisfied.
Altering sound user action
   Sₐ(u,v)=1 If the user turned the volume on or increased the volume on an ad impression.
   Sₐ(u, v)=0 if the above condition is not satisfied.
Rewind user action:
   Sₐ(u,v)=1 If the user rewound the ad impression, in part or full, and watched part of the ad creative more than once,
   Sₐ(u,v)=0 if the above condition is not satisfied.

In an embodiment, the engagement rate of the ad creative may be determined using the following formula (1) as shown below:

$$Engagement Rate = \frac{{\sum }_{u ∈ U} {\sum }_{v ∈ Vu} {\sum }_{a ∈ A} {w}_{a} * {S}_{a} ( u , v ) / \vert {V}_{u} \vert}{\vert U \vert} \qquad ( 1 )$$

where wₐ is a weight of user action a, and ΣaεA wₐ=1.

In an embodiment, each user action can be given an equal weight by having wₐ=1/|A|.

The engagement rate metric measures an effectiveness of the ad creative as a ratio of a number of responsive users to a total number of users to whom the ad creative was served. In other embodiments, the engagement rate may be measure using other formulas. In addition to the ad creative, the engagement rate can be used to determine effectiveness of other online content, such as web pages, videos, audios, etc.

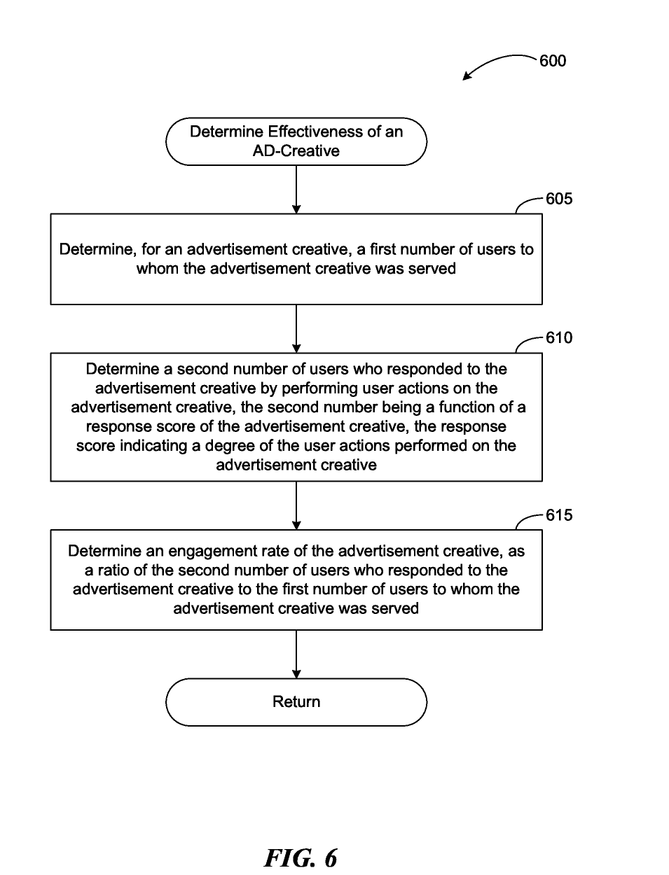

FIG. 6 is a flow diagram of a process 600 for measuring effectiveness of an ad creative, according to an embodiment of the disclosed technique. The process 600 may be executed in a system such as system 400 of FIG. 4A. At step 605, SSP determines a first number of users to whom the ad creative is served. In an embodiment, the first number of users may be measured as a total number ad impressions served. At step 610, the SSP determines a second number of users who responded to the ad creative by performing user action on the ad impression. At step 615, an engagement rate of the ad creative is determined as a ratio of the second number of users who responded to the ad to a first number of users to whom the ad creative was served. The engagement rate provides the effectiveness the ad creative.

Referring back to step 610, the second number of users is determined as a function of a response score of an ad creative. The response score indicates a degree of the user actions performed on the ad impressions of the ad creative. The response score is determined for each type of user action. In another embodiment, the second number of users may be measured as a function of a number of ad impressions on which users performed user actions.

### Measuring Viewable Time of an Advertisement Creative

As explained above, in some instances, a user's level of engagement with an ad create can be gauged by the user's response to the ad creative (also referred to as “ad” or “ad content”). Further, the user's level of engagement may be utilized in determining the ad's effectiveness on the user. In some embodiments, the ad's effectiveness on the user is utilized when determining a cost for displaying the ad to the user. In one instance, the ad's effectiveness on the user is measured as a function of the duration of time the user possibly paid attention to the displayed ad (also referred to as the “measured viewable time” of the displayed ad).

In some embodiments, the user's attention can be measured as a function of the proportion of the displayed ad (or that of any content whose user attention is being gauged) viewable (i.e. visible) to the user through a web client (e.g., a web browser). When the displayed proportion of the ad is below a minimum threshold possibly needed to draw the user's attention to the ad, the user is not likely to have paid any attention to the displayed portion of the ad (i.e. measured viewable time is zero). In one embodiment, the information on the position of the ad content relative to the region of the ad content displayed by the web client is gathered every tₛ seconds. Let h and w be height and width of the content, respectively. Using the position information, ratio rᵥ of size of the viewable part of the ad content to the size of the whole ad content is computed as rᵥ=(Sᵥ)/(h×w), where Sᵥ is the area of the portion of ad content that is being shown on the web client. In one example, the minimum threshold (θᵥ) can be set to 0.5, where only ad content with ratio rᵥ>=θᵥ are considered to have the user's attention.

In some embodiments, the user's attention can be further measured as a function of the visibility (also referred to as the “focus”) of the web client displaying the ad to the user. In one instance, when the web client is not visible to the user, the user can be deemed to be paying little attention to the ad being displayed by the web client (i.e. measured viewable time is zero). For example, a web browser displaying the ad might be blocked from the user's view by the window of another application running on the user's computing device, leading to little user attention to the displayed ad. In another example, a web browser with multiple tabs might simultaneously display multiple web pages but only content displayed in one of the tabs that is actively being viewed by the user is in focus (i.e. visible to the user). If the displayed ad is not in the actively viewed tab, then the user is paying little attention to the displayed ad.

In some embodiments, the user's attention can be further measured as a function of one or more user actions with respect to the web client. In one embodiment, a user's is paying attention to the web client and possibly to the portion of ad content being displayed by the web client when the user performs at least one or more user actions (from a subset of possible user actions that indicate user's interaction with the web client) every tᵤ seconds since the last performed user action (with respect to the web client). In one instance, tᵤ is a predefined threshold value empirically determined such that at least one user action performed every tᵤ seconds show user's continued attention.

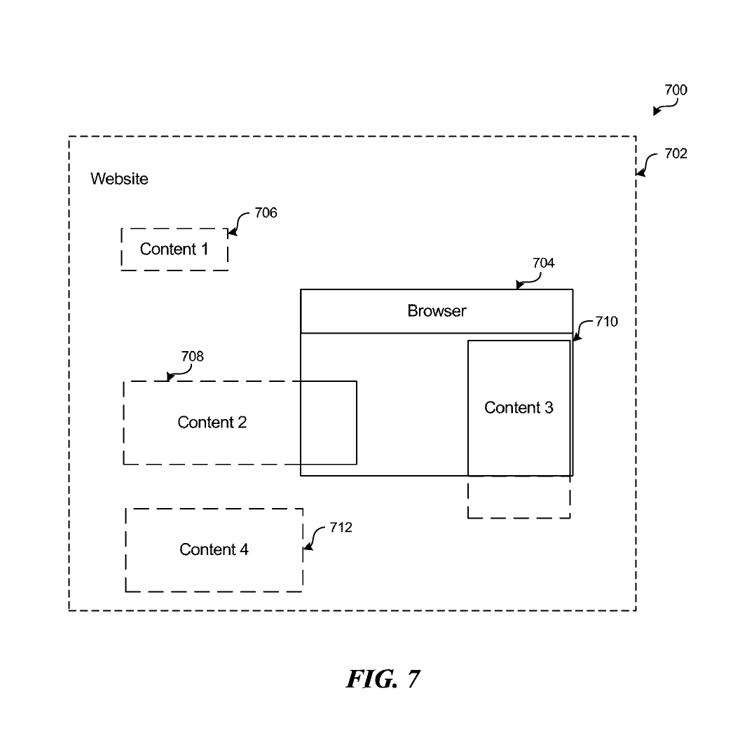

FIG. 7 is a block diagram 700 illustrating the measurement of a user's attention to various content areas 706-712 (e.g., ad slots) displayed across a web page 702, where some of the content areas 708, 710 are displayed to the user through a web browser 704 while the others are not 706, 712. As discussed above, the user's attention can be measured as a function of a proportion of a given content's area displayed to the user, focus of the web browser 704 to the user, and the user actions with respect to the web browser 704. Content of the web page 704 within the web browser 704 are displayed to the user while the content of the web page 704 outside the web browser 704 are not.

Here, content #1 706 and content #4 712 are outside the web browser 704 and therefore no portion of the contents 706, 712 are displayed to the user, thus each garnering little user attention (or zero measured viewable time). On the other hand, content #2 708 and content #3 710 are partially visible to the user. Content #3 710 has a large proportion of the content displayed (possibly exceeding the θᵥ threshold) to the user through the web browser 704 and can garner viewable time when other conditions (if any) for user's attention measurement are met. On the other hand, content #2 708, while displayed partially, has a small proportion of the content displayed (possibly lower than the θᵥ threshold) to the user through the web browser 704 and cannot garner viewable time even when other conditions (if any) for user's attention measurement are met.

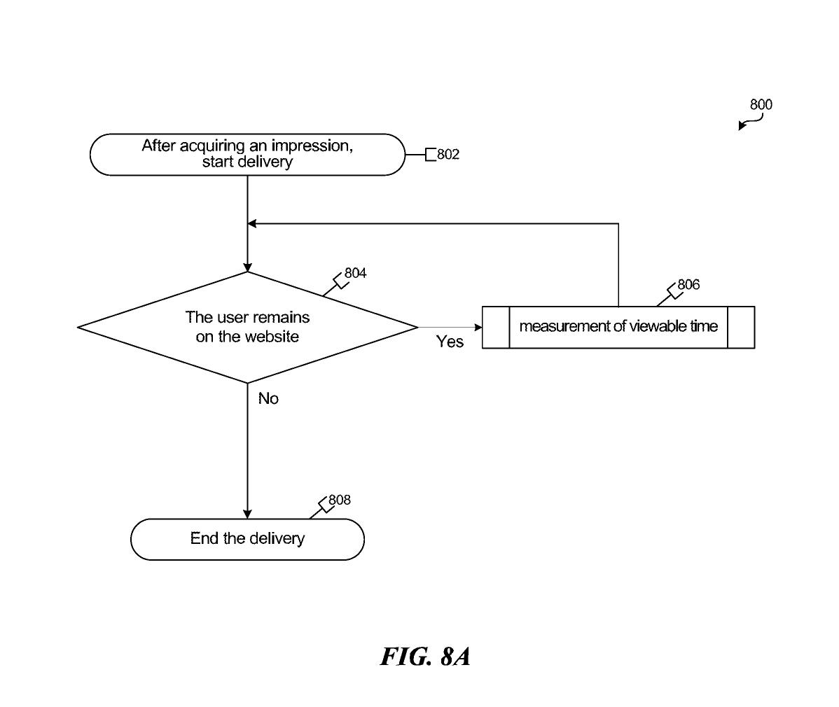

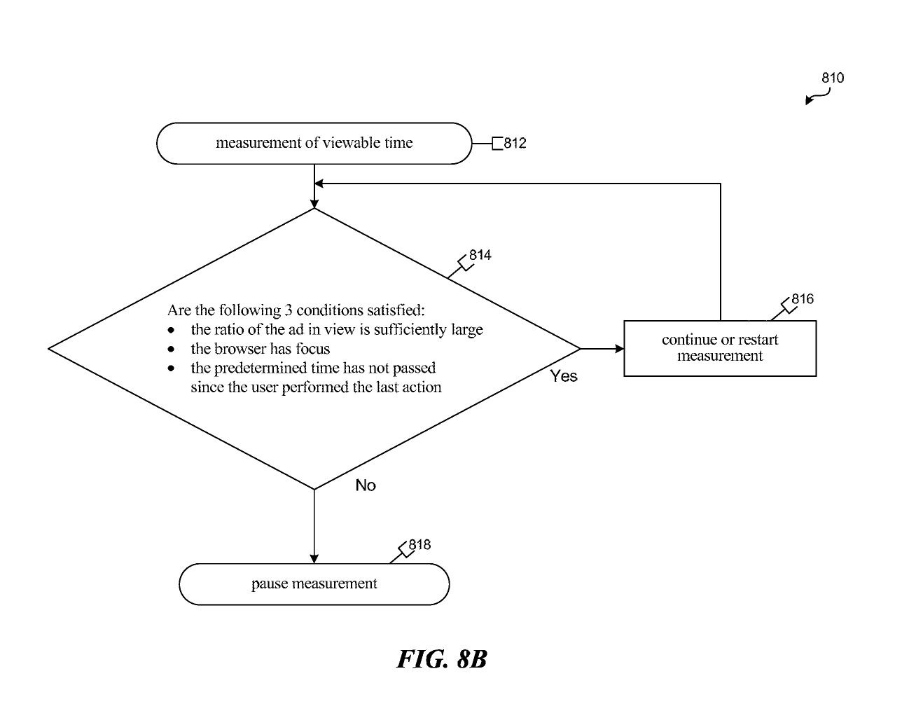

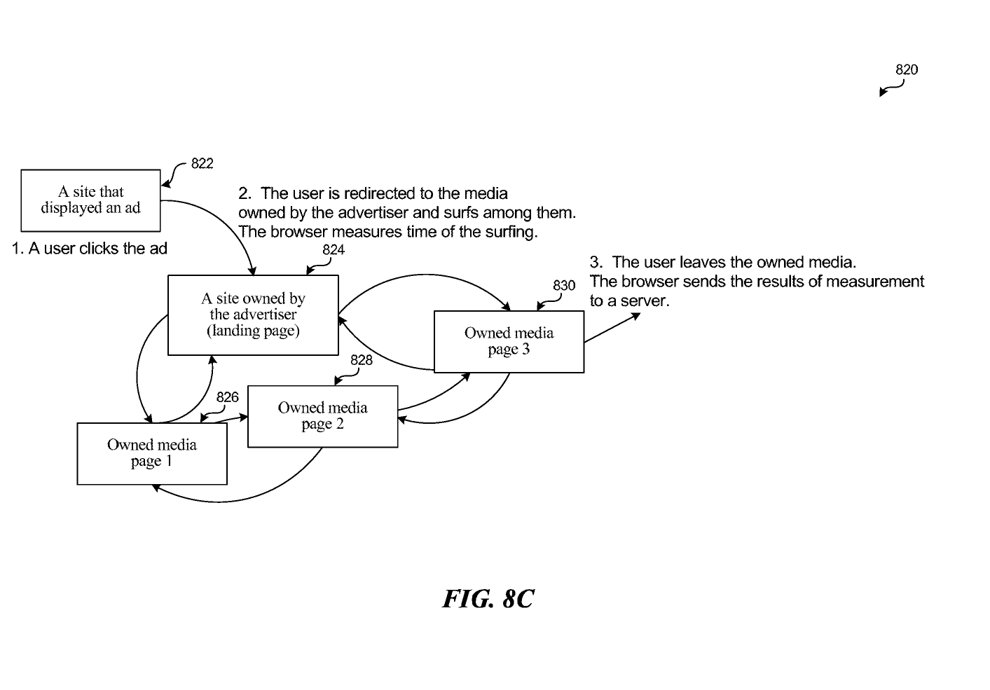

FIG. 8, which includes FIGS. 8A, 8B and 8C, shows a method 800 that can be utilized by the system 415 to measure viewable time for an ad content displayed in a given impression on a given web page (also referred to as a “website”). In step 802 of the method 800, the system 415 starts delivery of the ad content to be displayed to the user through the given impression. In step 804 of the method 800, the system 415 determines whether the user still remains on the given web page with the given impression. The step 804 can be performed using any well known methods, such as determining if at least one of the web pages open in the web page has the same web address as that associated with the given web page. If the user is determined to be still on the web page in step 804, in step 806 of the method 800, the system 415 measures viewable time (i.e. user's attention duration) of the displayed ad content. However, if the user is determined to have left the web page with the impression in step 804, in step 808, the system 415 stops delivery of the ad content to be displayed to the user.

In one embodiment, the system 415 measures viewable time of the displayed ad content using the method 810. In step 812 of the method 810, the system 415 begins measurement of the viewable time of the ad content. In step 814, the system 415 determines if the following three conditions are met: (1) the proportion of a given content's area displayed to the user greater than θᵥ; (2) focus of the web browser to the user; and (3) the user actions with respect to the web browser. If the conditions are met, the system 415 proceeds to step 816 and continues measuring (or starts measuring if its beginning the viewable time measurement process) the duration of time as the ad is being displayed in the given impression. After the lapse of the a predetermined time period, the system 415 again evaluates step 814 to determine if the user's attention is still possibly focused on the ad before continuing to measure viewable time for the ad. If the conditions are met, the system 415 continues to measure viewable time for the displayed ad. However, if the conditions are not met in step 814, the system 415 proceeds to step 818 and pauses measurement of the viewable time. The system 415 determines if the user is still on the web page in step 804 before resuming the measurement of viewable time in step 806.

### Owned Media Viewable Time

As discussed above, a user's level of engagement with an ad create can be utilized when determining a cost for displaying the ad to the user. In one instance, the ad's effectiveness on the user is measured as a function of not only the duration of time the user paid attention to the displayed ad (i.e. the measured viewable time of the displayed ad) but also the duration of the time the user spent on any landing page provided to the user when the displayed ad is clicked by the user.

In the present-day online advertising industry, the billing system charges for one click on an advertisement by a user (capturing both the user engagement with the displayed ad and a potential interest in the advertised product). However, the true value of a click (i.e. the potential interest of the user in the advertised product) can be best measured as the time the user spent on the landing site (associated with the clicked ad) which is owned by the advertiser that further market the product/message in the clicked ad. Such a measured time is defined as owned media viewable time (OMVT), which is the effective amount of time a user spent on the landing site. This enables us to measure the true value of clicks, which has previously been obscure and doubtful. Further, in the following discussions, the OMVT can be considered equivalent of measured viewable time (discussed above) and the various pricing models and systems can be implemented with OMVT when applicable.

FIG. 8C provides an illustration of a method 820 that can utilized to measure OMVT. In the method 820, the landing web page 824 that a user is redirected to after clicking an ad 822 is usually a medium owned by the advertiser. The viewable time is measured with the whole web page 824 as one web content. That is, the viewable time is measured when any portion of the web page 824 is visible in the web browser (as the rᵥ will be equal to 1 given that any content displayed in browser is considered monitored content) and the browser tab showing web page 824 is in focus and attracting a user action (the three conditions discussed above when measuring viewable time for displayed ads).

If one of the conditions above becomes unsatisfied, the measurement of the viewable time is paused. If the conditions are all met after the measurement was paused, the measurement of the viewable time is resumed. Here, owned media viewable time (OMVT) is determined by summing up viewable time of each page in the web site, as below: 1. Let p₀ be the landing page 824 associated with the advertiser of the advertisement (which when clicked lead the user to the landing page 824). Let us further assume the user viewed pages p₁, . . . , pₙ 826-830 during the session (all advertiser owned pages) before leaving the advertiser owned pages, and let t₀, . . . , tₙ be viewable time measured on each page.

In one embodiment, all the web pages associated with a webpage the original landing page is associated with are all considered advertiser owned pages when determining OMVT. For example, if the landing page is a marketing webpage for one of the products (e.g., a weight-lifting machine) sold by the advertiser and the user viewed additional web pages that correspond to one or more other products (e.g., a bench-press table, etc.) sold by the advertiser, then all the pages viewed by the user during the user's visit to the website of the advertiser are considered when measuring OMVT for that user visit.

In embodiments, the user's visit to the one or more pages in the advertiser's website can be contiguous (i.e. all the web pages viewed by the user during a session are associated with the a website of the advertiser or one or more related websites of the advertiser) or be interrupted by the user's visit to one or more other web pages not associated with the advertiser. In the event the user's visit to the one or more pages in the advertiser's website is interrupted by the user's visit to one or more other web pages, an interrupt can be considered an end of the user's session for measurement of OMVT when the interrupted time between the viewing of web pages belonging to the advertiser is exceeded by a predefined minimum time period. In one instance, the predefined minimum time period can be determined by analyzing an exemplary data set to determine the extent of interrupt that results in previously viewed pages having lesser effect on a later viewing of other related pages by the user.

Then, as shown in FIG. 8C, OMVT “T” is defined as T=t₀+ . . . +tₙ, the sum of the viewable time of pages p₁, . . . , pₙ 826-830 associated with the advertiser. Thus, similar to measured viewable time, OMVT is the duration of time in which the owned media had the user's attention.

Ad Serving in Pace with Measurement

As discussed above, the measured viewable time of an ad content displayed to the user can be very effective in gauging the user's attention to the displayed ad content, which can in turn help an advertiser or any interested party assess a potential impact of the displayed ad content on the user more accurately than the existing methods allow.

In one embodiment, when the measurement of viewable time is in progress, the system 415 can infer that the user is possibly paying attention to a displayed ad content (the viewable time is being measured for). Based on the inference, the system 415 can increase the possibility that ads with real-time change (e.g., video ads, game ads, etc.) gets users' attention by serving them in pace with the measurement of viewable time for the ads. For example, in one method, the system 415 starts delivering an ad (e.g., play a video ad) when the measurement the viewable time for the ad is in progress (and not paused). Here, if the ad had already started delivering to the user before it was paused (either by the user or by the system 415 when the user stopped paying attention to the ad), the system 415 can restart it from the paused time point when the measurement the viewable time for the ad progresses again. Further, if the measurement is paused (i.e. when the user stops paying attention to the ad), the ad delivery is paused (e.g., the video ad is paused if playing). Additional details of a method for pausing and playing ads in pace with user attentiveness are disclosed in, for example, commonly-assigned U.S. patent application Ser. No. 13/570,831.

### Pricing Models Based on Measured Viewable Time

As discussed earlier, the measured viewable time captures possible users' attention to a displayed ad, where the viewable time is correlated with the possible extent of the displayed ad's effect on the user. One or more ad pricing models that assess the cost of displaying the ad to the user based on the extent of the effect on the ad on the user (as determined by the measured viewable time) will be very useful to advertisers and other interested parties who wish to determine their ad spending based on measurable results (e.g., the extent of effect on user as a function of the various measured viewable time for the ad).

### CPV Pricing Model

CPV model is a pricing model that can be used to charge an advertiser only when their ad acquires more viewable time than a predetermined duration (say, provided by the advertiser). So, if the ad is not delivered for the predetermined duration, the advertiser incurs no cost for the ad already displayed to the user. The following discussion provides a method that can be utilized to implement the CPV pricing model.

In this method, a predetermined value “T” equal to the amount of guaranteed viewable time for a given ad is set by one of the interested parties, such as the advertiser, the DSP, etc. If an ad does not acquire viewable time more than “T” seconds with an ad delivery (or a series of ad deliveries, using the “ad-follow” method described later), then the advertiser is not charged for any portion of the ad delivery. The method then measures the viewable time Tᵥ achieved from an ad serving (or a series of servings in the “ad-follow” method) of the given ad to a user.

If Tᵥ>T, then the method charges the advertiser an amount for the ad delivery. The amount charged can be determined in several manners including: (1) the amount determined through negotiation with the advertiser; (2) the amount arrived through at an auction of the impression (used to display the ad to the user); (3) as a function of the cost-per-second and the measured viewable time Tᵥ. The proposed CPV pricing model can be implemented by the SSP, DSP, or any third-party ad server that can be enabled to gather or receive the viewable time for a given ad. Additional details of how the various parties implement the various pricing models are discussed in detail later.

### General Overview of Various Systems Implementing the Pricing Models

The viewable time underlying the various pricing models and the methods to perform evaluation of bids, delivery charges, realization, etc., can be measured and implemented by various participants, including a DSP, a SSP, any third-party ad server, a publisher, etc.

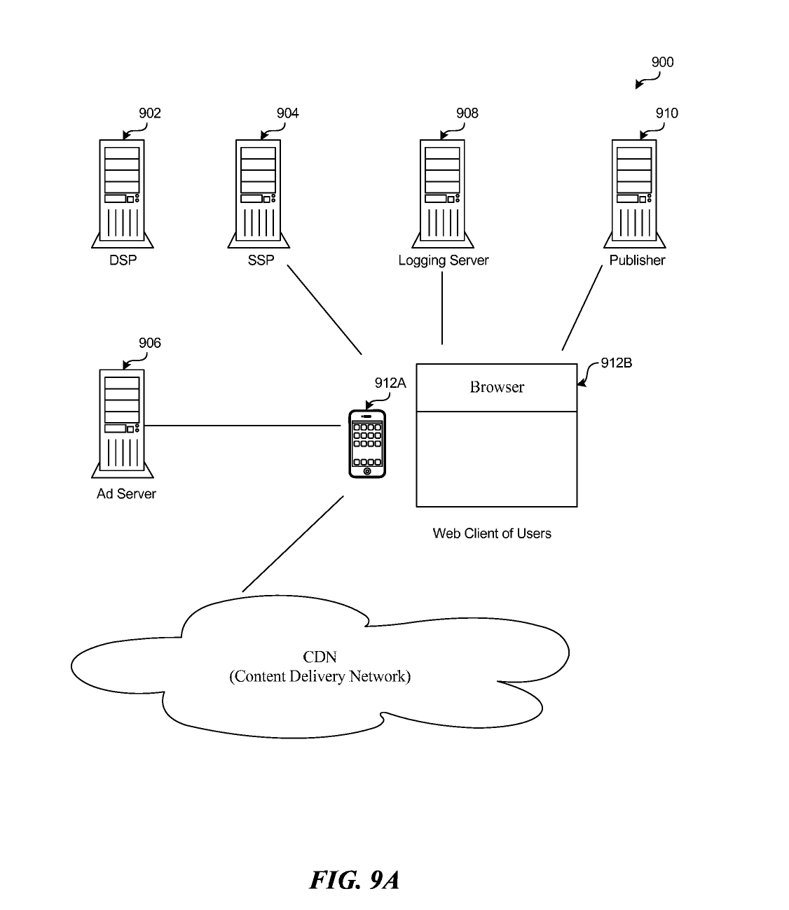

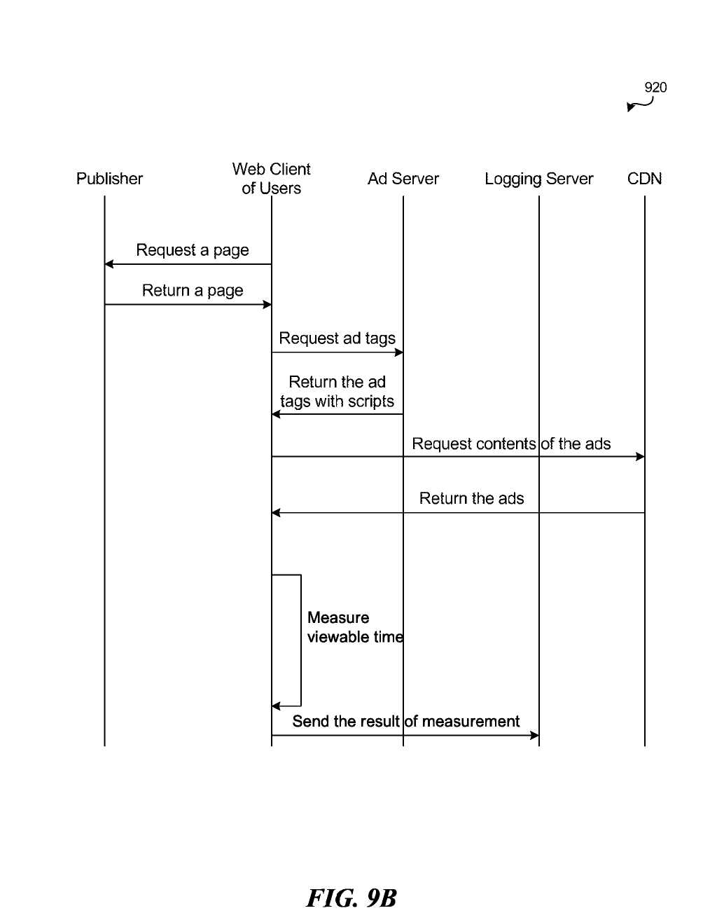

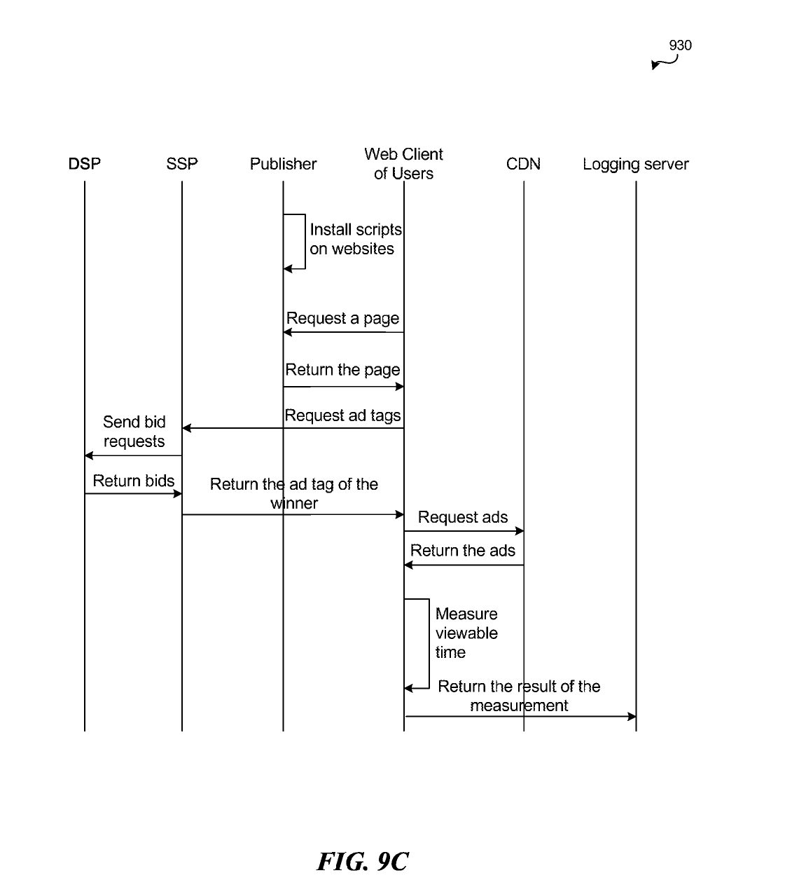

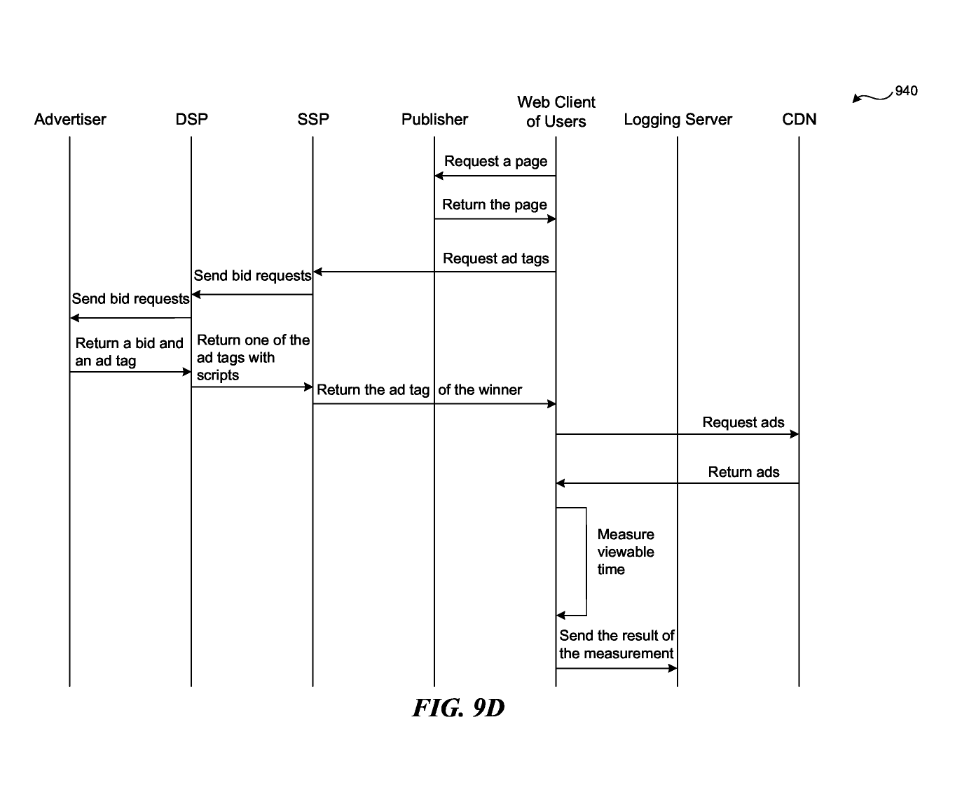

FIG. 9, which includes FIGS. 9A, 9B, 9C and 9D, provides an illustrative example of various methods that can be utilized by the various participants implementing the pricing model.

FIG. 9A illustrates the various participants in a general environment 900 the user is interacting with when the user is engaged in any activities over the internet. In FIG. 9A, the user engages online using a mobile device 912A running a web browser 912B (i.e. a web client). When the user visits a website hosted by the publisher 910, the ad server 906 or the SSP 904 sends ad tags to the user's web browser 912B. The tags in turn direct the web browser 912B to download ads from the Content Delivery Network (CDN). Further, the DSP 902 interacts with the web browser indirectly through the SSP 904. Also, the Logging server 908 may be utilized to receive information regarding the acquired viewable time for each given ad served in a given impression during the measurement of users' attentiveness. Although this reporting might degenerate the quality of measurement (since making a report to a server takes time), the measurement is taken before the reporting confirms that the impression acquired “T” seconds of viewable time and thus remaining a valid data.

FIG. 9B illustrates the interaction 920 between the various participants when the pricing models are implemented by the third party ad server 906. Here, the web client (i.e. the web browser) of the client 912B initiates a page request with the publisher 910. The publisher 910 provides the client 912B with the requested page. The client 912B then sends out request for ad tags for one or more ad slots (present in the received page from the publisher 910) to the ad server 906. The ad server 906 in turn returns the ad tags (which are associated with ads to be displayed in the ad slots) with scripts to perform various functions, such as monitor user actions, measure user attention, etc. The client 912B sends the received ad tags to the CDN to request for the ad content associated with the ad tags. The CDN responds to the request by sending the ad content associated with the ad tags to the client 912B. The client 912B displays the received ad content to the user. Further, the client 912B further measures the viewable time for the displayed ad (when the various conditions for user attention are met as discussed above). When the display of the ad content ends or the user ends the session, the measured viewable time are forwarded to the logging server that can be utilized by any of the other participants (including the third-party ad server) to implement the pricing model and determine the cost for ad delivery.

FIG. 9C illustrates the interaction 930 between the various participants when the pricing models are implemented by the SSP 904. Here, the various scripts (discussed above) are installed within the publisher's 910 websites and gather the necessary data when a user visits the websites. Also, here, the SSP 904 receives the request for ad tags (instead of the ad server 906 as before). In response to the request for ad tags, the SSP 904 in turn sends bid requests to DSP 902 for ads to be displayed in the ad slots associated with the ad tag requests. The DSP 902 sends a bid value and the ad to be displayed in the ad slot if the DSP's 902 bid is successful. The SSP 904 evaluates the various return bids and forwards the ad tag associated with the ad in winning bid to the client 912B. The rest of the functions, including measuring and storing viewable time for each displayed ad, are performed similar to those functions performed with the ad server 906 as the participant (in FIG. 9B).

FIG. 9D illustrates the interaction 940 between the various participants when the pricing models are implemented by the DSP 902. Here, the various scripts (discussed above) are provided within the ad tags forwarded to the client. In response to a bid request, the DSP 902 in turn forwards the bid request to various advertisers. The advertisers evaluate the bid request and respond back with a bid and an ad tag of the ad to be displayed in the ad slot (associated with the bid request) in the event of a winning bid. The DSP 902 evaluates the various received bids and forwards one of the bids (e.g., the one with the highest bid amount) to the SSP 904 along with the scripts. The SSP 904 in turn evaluates the bids from the various DSPs 902 and sends the ad tag of the winning bid to the client 912B. The rest of the functions, including measuring and storing viewable time for each displayed ad, are performed similar to those functions performed with the ad server 906 as the participant (in FIG. 9C).

### Ad Targeting

The various pricing models discussed earlier utilize the viewable time as one of the key parameters. The viewable time in turn depends on the user attention (or engagement) to the one or more displayed advertisements. The various participants in the ad ecosystem can enhance the realization under the viewable time by boosting the user attention to the displayed ad. In one instance, serving ads that are relevant to a given user can enhance engagement of the user. That is, by delivering ads that a user is likely to be interested is will increase the attention of the user to the delivered ad.

The following discussion provides an illustration of an ad targeting method that can be implemented by one or more participants in the ad ecosystem to enhance user engagement to a displayed ad. In embodiments of the ad targeting method, the priority (or order) of ads being delivered to the user can be determined based on the information regarding the user, such as the user's interests, age, gender, etc. where such prioritizing of ads for enhancing user attention is called targeting.

Further, in embodiments, the ad targeting method increases a user's engagement to the displayed ad by limiting the number of times a particular ad is shown to the user (also referred to as the “frequency limit” of a given ad) and showing, instead, ads that were previously not shown to the user or only shown to the user a fewer number of times (i.e. less than a predefined number of times). Also, by limiting the number of times a particular ad is shown to the user, an ad campaign with a limited budget can reach a wider audience by not repeatedly showing the ads from the ad campaign to a small subset of users. In embodiments, the number of times a particular ad can be shown to a given user (i.e. the limit) can be empirically determined such that the viewing of the given ad over the limit has minimal impact on the given user in achieving the objective of the given ad. In embodiments, a given user can be identified using any of the well-known online user tracking techniques, such as utilizing cookies, IP-address association, UID (User ID) included in a bid request from a RTB platform, etc.

In embodiments of the ad targeting method, an instance of showing of a given ad to a given user at a given time is determined as a function of viewable time achieved in the showing of the given ad to the given user at the given time. In embodiments, the ad targeting method counts an instance of showing of a given ad to a given user at a given time to have been achieved when the viewable time measured during the showing of the given ad to the given user at the given time crosses a certain predefined threshold. In embodiments, the certain predefined threshold can be defined as a percentage of total display duration of the given ad at the given time. In embodiments, the total display duration of the given ad at the given time is based on the length of the given ad (e.g., a rich media ads, such as video ads).

In embodiments, the total display duration of the given ad at the given time is based on the length of display time available for a given ad slot where the given ad will be displayed (e.g., a banner ad of a static image). For example, let video ad “A” of total length 20 sec be displayed to user “u” at a given time and let the certain pre-defined threshold for counting the display of ad “A” to user “u” be 40%. So, if the measured viewable time (as discussed earlier) from the display of ad “A” to user “u” at the given time crosses at least 8 sec, then the display of the ad “A” to user “u” is counted as an instance of showing (also referred to as the “view-through”) of the ad “A” to user “u”.

In embodiments of the ad targeting method, an instance of showing of a given ad to a given user is determined as a function of viewable time achieved in the showing of the given ad to the given user over one or more display opportunities. In the above example, if the user “u” viewed (i.e. measured viewable time) ad “A” a certain number of times but each time below the threshold value of 8 sec to be considered a view-through of the ad “A” by user “u”, then each viewing of the ad “A” for the certain number of times but below the threshold value of 8 sec can be considered an instance of the view-through of ad “A” by user “u”. In embodiments, the certain number of times considered equivalent to a “view-through” can be empirically determined such that the viewing of the ad “A” the certain number of times had the equivalent impact of having a “view-through” of the ad “A”.

The ad targeting method is further explained with the help of the following example. When a user “u” accesses a web page “m”, an impression is generated in an ad slot Fₘⱼ present on the web page “m”. The impression represents an opportunity for advertisers to display their advertisement to the user in the ad slot Fₘⱼ as the user is viewing web page “m”.

When bidding for the impression, the various participants of the ad ecosystem, such as a third-party ad server 906, DSP 902, perform targeting by determining an ad relevance score for one or more possible ads from the available ads that could be displayed to the user “u” and prioritizing displaying of the one or more possible ads based on the determined ad relevance score. Factors associated with “a”, “u”, Fₘⱼ, etc., used in targeting include, but not limited to, the followings.

Various factors associated with a given ad “a” that are analyzed during ad relevance score determination includes: (1) the extent of achievement of the campaign that ad “a” belongs to; (2) the remaining budget of the campaign containing “a”; (3) the desired bid amount of the campaign containing “a”; (4) the quality of ad a's creative; (5) whether ad “a” is the candidate for successive delivery (discussed in detail later); and (6) whether “a” is delivered to some other ad slot Fₘₗ of web page “m”.

Various factors associated with user “u” that are analyzed during ad relevance score determination includes: (1) geographical location of user “u”; (2) IP address associated with user “u” internet connection; (3) cookie information from user's computing device; (4) the kind of the user's browser or OS; (5) language of the user; and (6) the referrer URL (URL of the website visited just before “m”).

Various factors associated with ad slot “Fₘⱼ” and the web page “m” that are analyzed during ad relevance score determination includes: (1) estimated price for the ad slot (CPM, CPS, etc.); (2) average performance of the slot (click through rate, conversion rate, etc.); (3) average viewable time; (4) the number of impressions per unit time; (5) users' average dwell time; (6) the size of the ad slot (height and width); (7) URL of web page “m”; (8) category of “m”; and (9) whether or not we obtain the other ad slots Fₘₗ in “m” (allowing for ad-follow and other strategies as discussed later).

In the ad targeting method, the ad relevance score for each considered ad to be displayed in ad slot Fₘⱼ is denoted by “S”, where “S” for each considered ad is determined as a function (eq. (8) shown below) of B(a, t) (a bid value of “a” at time t without applying ad targeting), T(a, u, Fₘⱼ) (a bid value premium based on the effect of targeting), c(u, a) (the number of times user “u” viewed-through the ad “a”) and Cₐ (the predefined limit for the number of times the ad “a” can be shown to a given user).

S(a,u,fₘⱼ)=1_{c(u,a)≦c}_{ₐ}·(·λ·B(a,t)+(1−λ)·T(a,u,fₘⱼ)) (8)

where, 0<λ<1 is a constant that determines the weight of the parameters of eq. (8) and 1_{c(u, a)≦Ca} is a function that is set to 0 if c(u, a)>Cₐ (i.e. when number of achieved view-through is less than the frequency limit) and 1 otherwise.

In one embodiment, B(a,t) is estimated as a function of a bid amount the advertiser, associated with ad “a”, is willing to pay and the current campaign goal (of the advertiser the ad “a” is associated with) achievement progress. In general, an ad campaign's goals are generally defined in terms of certain metrics such as total number of view-throughs for various ads that belong to the ad campaign, total viewable time achieved by all the ads in the ad campaign, etc. Let the achievement of the campaign corresponding to ad “a” at time “t” be denoted by 0<rₐ(t)<1 and let the expected achievement of the campaign at “t” be denoted by 0<\hat{r}ₐ (t)<1. Using the achieved and expected goal for ad “a”, bid amount B(a, t) of ad “a” at time “t” is calculated. At time “t”, comparing ad “a”'s actual achievement rₐ(t) and expected achievement \hat{r}ₐ (t), B(a,t) is computed using the function (9) shown below:

B(a,t)=B(a,t−1)−γ(F⁻¹(rₐ(t))−F⁻¹(\hat{r}ₐ(t))) (9)

where γ is a constant and F:(0,∞)→(0,1) can be any appropriate monotone-increasing function and B(a, t−1) is the previous bid amount computed for ad “a” at time “t−1” (i.e. the last computed bid amount) using function (9), resulting in the bid amount B(a,t) decreasing if ad campaign (the ad “a” is associated with) is exceeding its goal at time “t” and increasing if ad campaign is underperforming its goal at time “t”.

In one embodiment, “T” is estimated as the probability that the delivery of ad “a” to user “u” achieves a view-through, where a higher probability indicates a greater user engagement with the given ad “a”. By including “T” as a factor in ad relevancy score “S” assessment, the greater user engagement with ad “a” compared to the other considered ads increases the ad relevancy score “S” associated with ad “a”. This results in the ad “a” being displayed to user “u” even with a lower bid amount B(a,t) compared to other considered ads when ad relevancy score “S” of ad “a” is greater than other considered ads.

In embodiments, let p(a,u) represent the probability that the delivery of ad “a” to user “u” achieves a view-through. That is, p(a, u) is the probability that the duration of measured viewable time of ad “a” becomes equal to or greater than a certain predefined threshold associated with ad “a”. Further, let Xᵤₘⱼ be the feature (i.e. attributes) vector of user “u” and ad slot Fₘⱼ and let βₐ be the feature vector of ad “a”. Here, T(a, u, Fₘⱼ) is set to \hat{p}(a, u), where \hat{p}(a, u) can be determined using function (10) as shown below:

$$\hat{p} ( a , u ) = \frac{{C}_{0}}{1 + exp ( - {β}_{a}^{′} {X}_{umj} )} \qquad ( 10 )$$

where, C₀ is some constant. In function (10), a greater overlap (i.e. match) between the features of Xᵤₘⱼ (i.e. features of user “u” and ad slot Fₘⱼ) and features of βₐ (i.e. feature vector of ad “a”) shows a better match of the ad “a” to the user “u” to be displayed in the ad slot Fₘⱼ, resulting in increased probability value p(a, u) that reflects the likelihood of achieving an increased user engagement with ad “a”. Additional details of a method for ad targeting were attribute matching between users and available ads (which can be utilized in the conjunction with other ad targeting methods disclosed herein) are disclosed in, for example, commonly-assigned U.S. patent application Ser. No. 13/605,915.

In embodiments, the factor 1_{c(u, a)≦Ca} in ad relevance score “S”, representing whether a given ad, say ad “a”, has crossed the allowed number of view-throughs for ad “a” (i.e. the frequency limit of the ad “a”), can be determined as function of max(0, 1−c(u,a)/Cₐ). The ad relevancy score “S” reduces to zero when the ad “a” achieves its associated frequency limit, allowing other ads that have yet to reach their frequency limit and have ad relevancy score “S” greater than zero to be prioritized higher than ad “a” to be displayed to user “u”. On the other hand, when ad “a” hasn't achieved its associated frequency limit, the score “S” is scaled as a proportion of the remaining number of view-throughs for ad “a”, allowing ads that have achieved a lower number of view-throughs to have a greater ad relevancy score “S” (assuming other factors are the same) and higher display priority than ad “a”.

The following example provides an illustration of the view-through frequency limit associated with the ads and the resulting change in ad campaign reach (e.g., the number of unique audiences reached by the ad campaign for a given ad budget). Let ad “A” and ad “B” be two ads that can be served to users visiting the website “m”. Let Nᵤ be the unique number of users visiting website “m” twice, offering at least two opportunities to display ads to each of the Nᵤ users. Let ad “A” and “B” have the same cost basis C_{B}. In embodiment, the cost basis C_{B} can be determined as a function of the estimated bid amount for each ad. In embodiments, the cost basis C_{B} can be determined as a function of the estimated bid amount for each ad and a bid value premium based on the effect of targeting. Further, let the probability (p) of achieving a view-through for a given ad for any of the Nᵤ users in website “m” be set to p=0.05. In addition, let Cₐ (i.e. the view-through frequency limit) for a given ad be set to Cₐ=1, requiring just one view-through of the ad to reach the frequency limit.

Based on the above values, the ad platform, such as a third-party ad server 906, DSP 902, serving ads in the website “m” using the ad targeting method will estimate the ad relevancy score “S” for each of the potential ads that can served to each of the Nᵤ users and serve the ad with the highest score at a given time. As discussed above, the ad relevancy score “S” for a given ad can be estimated using function (11) shown below:

S(u,a)=max(0,(1−c(u,a)/Cₐ))·C_{B} (11)

When the ad relevancy score “S” result in a tie, each of the ad with the tie score can be equally likely displayed. To estimate the effect of implementing the frequency limit, let the ad platform implement a random ad serving scenario, where there is no frequency limit and any given ad can be served equally likely to a given user at a given time. In another scenario, let the ad platform implement an ad delivery scheme based on the ad relevancy score incorporating the frequency limit.

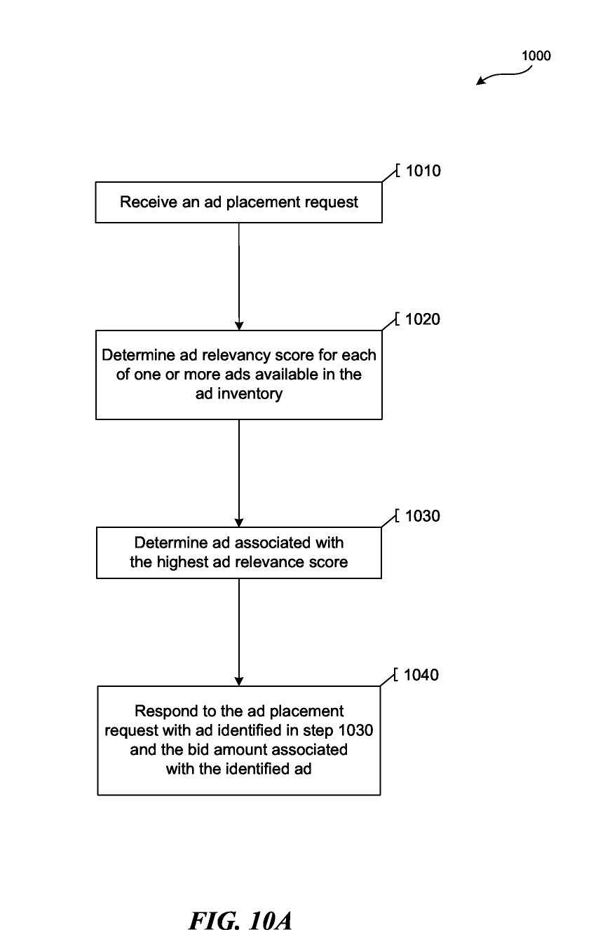

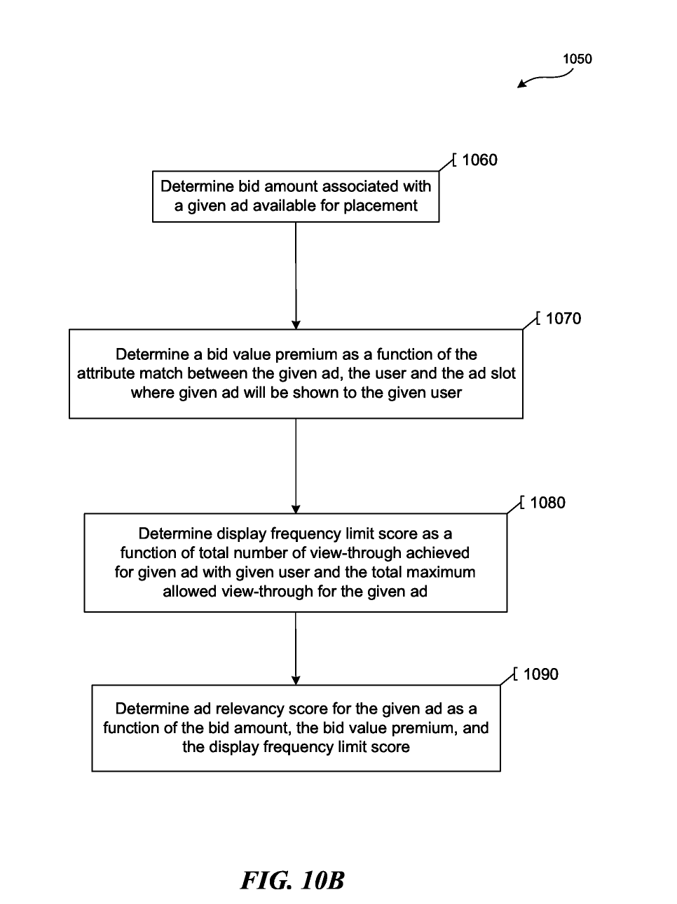

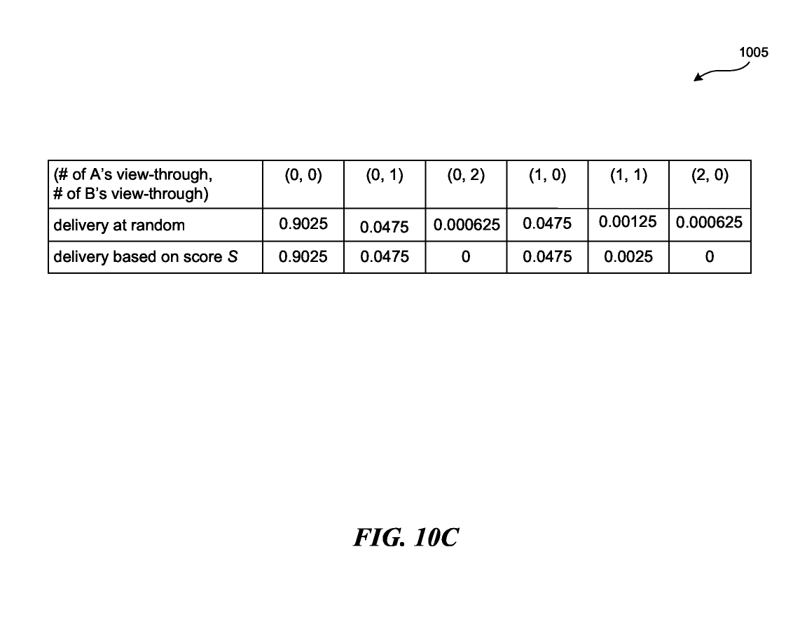

The table #2 1005, shown in FIG. 10C, illustrates the distribution of number of times each of ad “A” and “B” is viewed-through by a given user when visiting website “m”. As shown in table #2 1005, both the ad delivery schemes have the same distribution of ads “A” and “B” when neither ad “A” nor “B” achieves view-through (i.e. (0,0)). That is, as p=0.05 (the probability (p) of achieving a view-through for a given ad), then the probability of not achieving a view-through for a given ad is 1−p=0.95. So, the probability of neither ad “A” nor “B” achieving a view-through is 0.95*0.95=0.9025. Similarly, both the ad delivery schemes have the same distribution of ads “A” and “B” when one of ads “A” and “B” achieves view-through but not the other (i.e. (0,1) and (1,0)). This is understandable because, the ad platform will resort to random delivery of ads in either scenarios. That is, in the case of delivery based on “S”, the ad relevancy score for both ad “A” and “B” will be a tie before one of the ads can be picked in random and delivered to achieve (0,1) or (1,0).

Further, given the frequency limit Cₐ is set to 1, under the ad relevancy score based scheme, the probability of any of the ads “A” or “B” achieving two view-throughs (i.e. (0,2) or (2,0)) is zero as neither ad “A” nor “B” will be served more than once. Finally, given the frequency limit Cₐ is set to 1, under the ad relevancy score based scheme, the probability of both the ads “A” and “B” achieving view-throughs (i.e. (1,1)) within the allowed frequency limit (0.05*(1*0.05)=0.0025) is higher than compared to the probability of achieving view-throughs (0.05*(0.5*0.05)=0.00125) in the random delivery scenario. This is because, under the ad relevancy score based scheme, once one of the given ads, say ad “A”, reaches frequency limit, the ad served to the user in the next visit will be the remaining ad (i.e. ad “B”) and the probability both the ads “A” and “B” achieving view-throughs is simply a function of p. As shown, by implementing the ad delivery scheme incorporating frequency limit, the ad platform can increase the reach of a given ad campaign for a given ad budget.

FIG. 10A provides a method 1000 that can be utilized by an ad platform (e.g., third-party ad server 906, DSP 902, etc.) to implement ad delivery based on an ad delivery scheme incorporating ad targeting and frequency limit (for view-throughs). In step 1010 of the method 1000, an ad placement request is received by an ad platform, where the request, without limitation, could be in the form of a RTB bid request. In step 1020, an ad relevancy score for each of one or more ads available in the ad inventory is determined. In embodiments, ad relevancy score is determined for a subset of ads chosen from the available ads in the ad inventory, where the subset of ads could be chosen based on various criteria, such as whether the bid amount associated with the available ads are within a predefined range of the suggested bid value in the received bid request. In step 1030, the ad associated with the highest ad relevancy score is selected. In step 1040, an ad tag associated with the ad, which can be utilized to retrieve the ad creative from a repository, and a bid amount for displaying the ad associated with the ad tag is returned as part of a bid response

FIG. 10B provides a method 1050 that can be utilized by an ad platform (e.g., third-party ad server 906, DSP 902, etc.) to estimate ad relevance score for a given ad, which can then be utilized to prioritize available ads that can be displayed to a user or provided in a bid response. In step 1060 of the method 1050, a bid amount that an advertiser is willing to pay for display of the given ad is determined. In embodiments, the bid amount is increased or decreased based on the performance of any ad campaign the given ad is part of. In step 1070, a bid value premium based on the effect of targeting is determined. In embodiments, the bid value premium is determined as a function of the probability of achieving view-through for the given ad when the ad is displayed to the user. The probability increases when the user's interests (i.e. attributes) shows a high degree of match to the ad's content (i.e. attributes of content advertised) and decreases when the user's interests shows a low degree of match with the ad's content.

In step 1080, the display limit score that determines the extent of view-through achieved by the given ad is determined. In embodiments, the display limit score is determined as a function of ratio of view-through achieved for the given ad for the user and frequency limit associated with the given ad. In embodiments, the display limit score is set to zero when the view-through achieved for the given ad for the user is equal to the frequency limit associated with the given ad. In step 1090, the ad relevancy score is determined as a function of the determined bid amount (step 1060), the determined bid value premium (step 1070) and display limit score (step 1080). In embodiments, the eq. (8) can be utilized to determine the ad relevancy score based on the above factors.

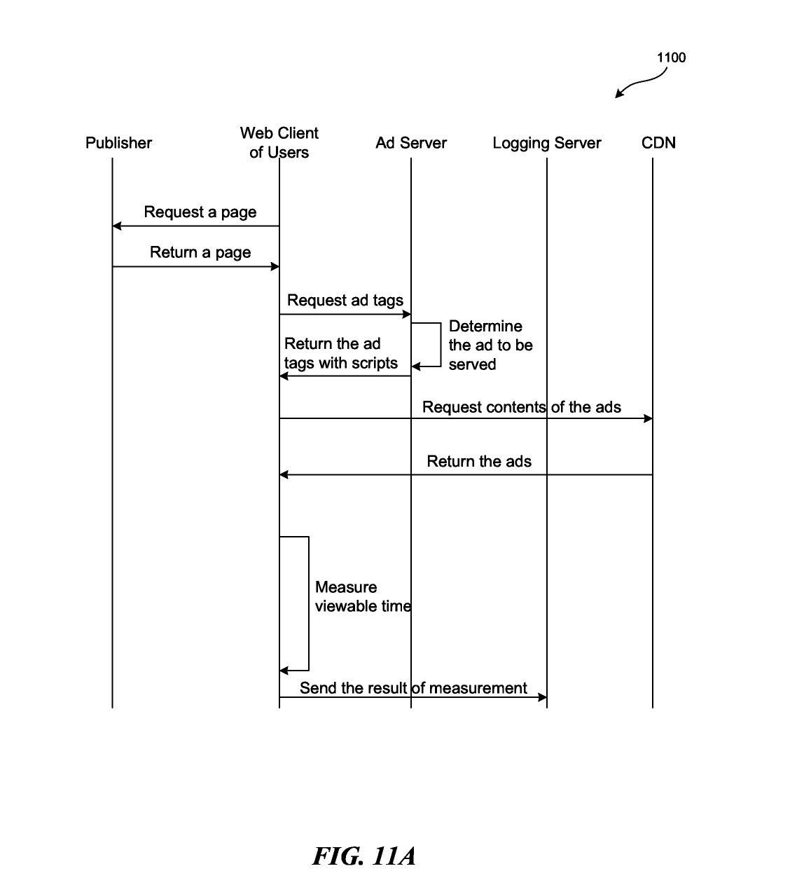

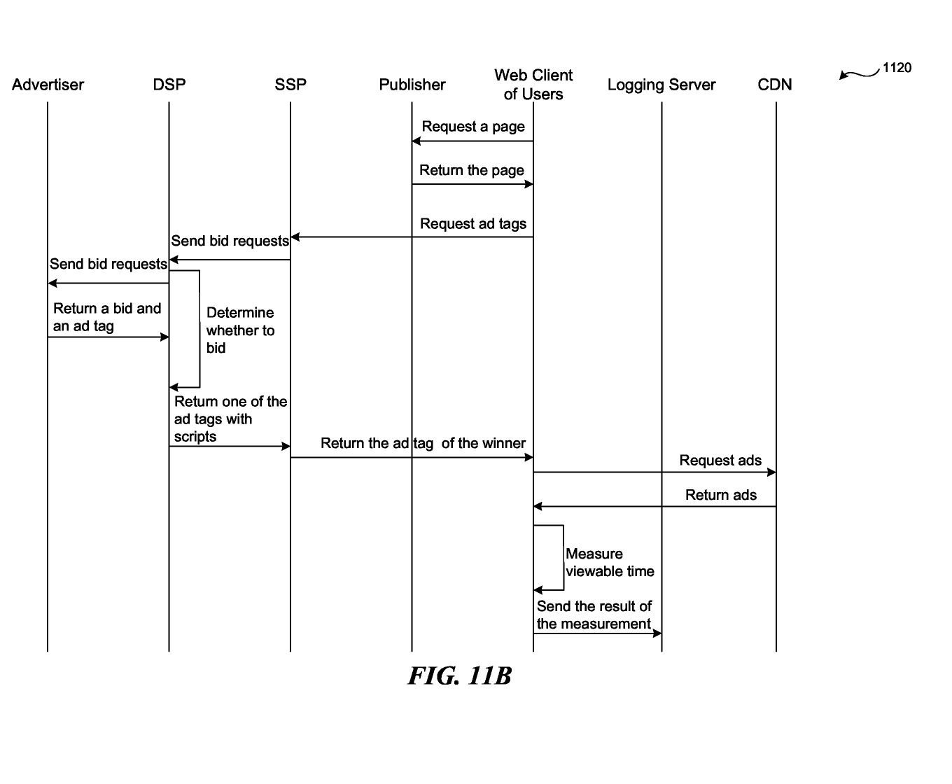

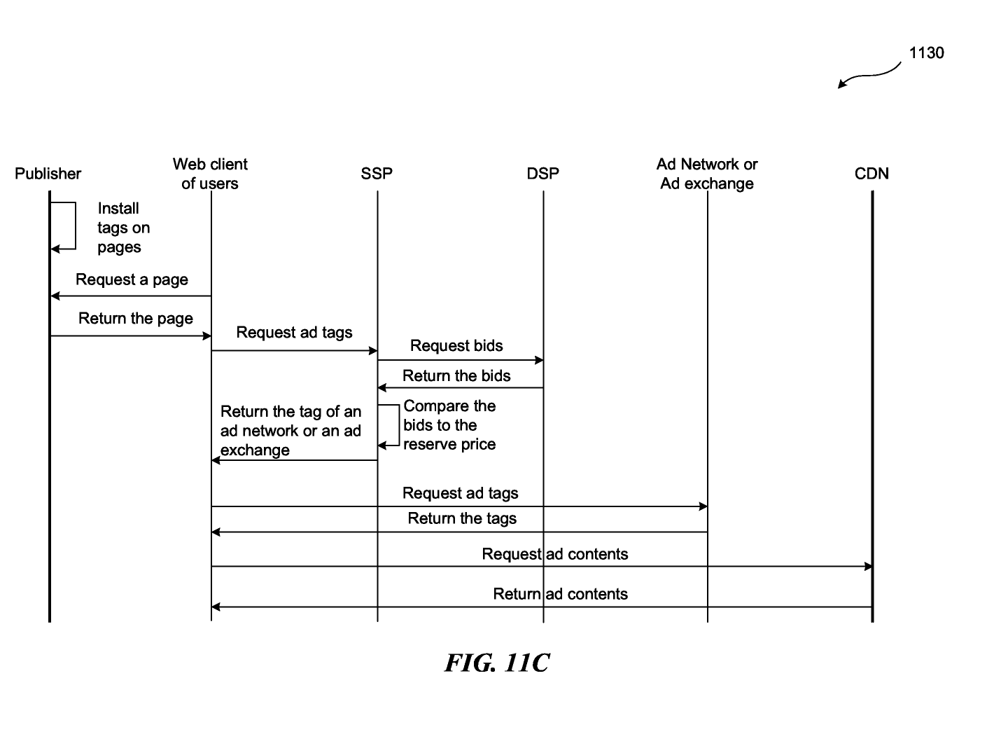

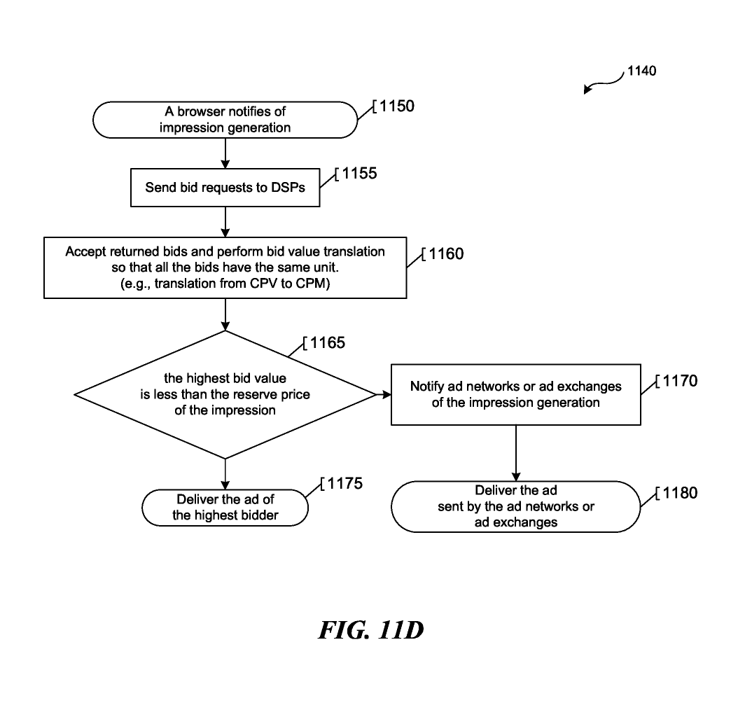

FIG. 11, which includes FIGS. 11A, 11B, 11C and 11D, provides an illustrative example of various methods that can be utilized by the various participants of the ad ecosystem to implement the ad targeting scheme.

FIG. 11A illustrates the interaction 1100 between the various participants of the ad ecosystem when the ad targeting scheme is implemented by the third party ad server 906. Here, the web client (i.e. the web browser) of the client 912B initiates a page request with the publisher 910. The publisher 910 provides the client 912B with the requested page. The client 912B then sends out request for ad tags for one or more ad slots (present in the received page from the publisher 910) to the ad server 906. The ad server 906, performing the ad targeting scheme, determines ad tags with the highest ad relevancy score from the available ad inventory, managed (directly or indirectly) by the ad server 906, for each of the ad slots available for ad display. In embodiments, the ad server 906 implements the method 1100 (discussed with reference to FIG. 10A) to implement the ad targeting scheme.

The ad server 906 then returns the determined ad tags (which are associated with ads to be displayed in the ad slots) with scripts to perform various functions, such as monitor user actions, measure user attention, etc. The client 912B sends the received ad tags to the CDN to request for the ad content associated with the ad tags. The CDN responds to the request by sending the ad content associated with the ad tags to the client 912B. The client 912B displays the received ad content to the user. Further, the client 912B further measures the viewable time for the displayed ad (when the various conditions for user attention are met as discussed above). When the display of the ad content ends or the user ends the session, the measured viewable time are forwarded to the logging server that can be utilized by any of the other participants (including the third-party ad server) to implement the pricing model and determine the cost for ad delivery.

FIG. 11B illustrates the interaction 1110 between the various participants when the ad targeting scheme is implemented by the DSP 902. Here, the various scripts (discussed above) are provided within the ad tags forwarded to the client. In response to a bid request to provide ads to a given user, the DSP 902 in turn forwards the bid request to various advertisers. In embodiments, the DSP 902 evaluates the ads of various ad campaigns and determines whether the ads from the various ad campaigns have reached their frequency limit for total view-throughs before forwarding the bid request to advertisers associated with the ad campaigns. When the ads from a given ad campaign have reached their frequency limit for total view-throughs for a given user, the DSP 902 does not forward the bid request to the advertiser associated with the ad campaign.

The advertisers who received a bid request from the DSP 902 then evaluate the bid request and respond back with a bid and an ad tag of the ad to be displayed in the ad slot (associated with the bid request) in the event of a winning bid. The DSP 902 evaluates the various received bids and forwards one of the bids to the SSP 904 along with the scripts. In embodiments, the DSP 902, performing the ad targeting scheme, determines ad relevancy score for each of the ads associated with the ad tags in the various received bids and chooses an ad tag with the highest ad relevancy score.

In embodiments, the DSP 902 implements the method 1100 (discussed with reference to FIG. 10A) to implement the ad targeting scheme. In method 1100, the frequency limit for total view-throughs for a given ad for a given user is incorporated within the ad relevancy score estimation, allowing the DSP 902 to implement frequency limit after the bids have been received from the advertisers. The SSP 904 in turn then evaluates the bids from the various DSPs (such as DSP 902) and sends the ad tag of the winning bid to the client 912B. The rest of the functions, including measuring and storing viewable time for each displayed ad, are performed similar to those functions performed with the ad server 906 as the participant (in FIG. 11A).

FIG. 11C illustrates the interaction 1130 between the various participants when the DSP 902, implementing the ad targeting scheme, returns a bid to the SSP 904 with bid amount that is lower than the reserve price the publisher 910 is willing to accept to display the ad from the DSPs. Here, the various scripts (discussed above) are installed within the publisher's 910 websites and gather the necessary data when a user visits the websites. Also, here, the SSP 904 receives the request for ad tags (instead of the ad server 906 as before). In response to the request for ad tags, the SSP 904 in turn sends bid requests to DSP 902 for ads to be displayed in the ad slots associated with the ad tag requests. The DSP 902 performs ad targeting and sends a bid value and the ad (based on its ad relevancy score) to be displayed in the ad slot if the DSP's 902 bid is successful. The SSP 904 evaluates the various return bids and forwards the ad tag associated with the ad in winning bid (that has the highest bid amount of the received bids and has bid amount over the reserve price of the publisher 910) to the client 912B. The rest of the functions, including retrieving ads associated with the ad tag, displaying the retrieved ad, measuring and storing viewable time for each displayed ad, are performed similar to those functions performed with the ad server 906 as the participant (in FIG. 11A).

When none of the received bids are over the reserve price of the publisher 910, the SSP 904 sends the tag of an ad network or an ad exchange (e.g., ad server 906) to the client 912B. The client 912B in turn distinguishes the tag of an ad network (or an ad exchange) from the ad tag associated with a winning bid and sends an ad tag request to the ad network associated with the tag received from the SSP 904. In response to receiving the ad tag request, the ad network returns ad tags that meets the publisher's 910 reserve price (where such information is included in the ad request when possible). The rest of the functions, including retrieving ads associated with the ad tag, displaying the retrieved ad, measuring and storing viewable time for each displayed ad, are performed similar to those functions performed with the ad server 906 as the participant (in FIG. 11A).

FIG. 11D provides a method 1140 that can be utilized by an SSP 904 to manage ad delivery in response to an ad tag request from a client when the received bid amounts from the DSPs (such as DSP 902) is lower than the reserve price the publisher 910 is willing to accept to display the ad from the DSPs. In step 1150, a client 912B sends an ad tag request to the SSP 904 by notifying an impression generation, where an ad could be served/displayed to the user through the client 912B. In embodiments, the client 912B performs pixel monitoring around a given ad slot (as discussed earlier with FIGS. 4A-4D) when notifying of impression generation. In step 1155, in response to the impression generation notification, the SSP 904 sends bid requests to DSPs to display ads in the ad slot associated with the generated impression. In step 1160, the SSP 906 receives the bid responses from the DSPs and performs bid translation (when necessary) to transform the bid amounts associated with the received bids to a common cost-basis (such as CMP, CPC, etc.) such that the received bid responses can be easily compared.

In step 1165, the SSP 906 determines if the highest bid amount (in the common cost-basis) is greater than the reserve price the publisher 910 (whose webpage hosts the ad slot associated with the impression) is willing to accept to display the ad associated with the highest bid. If the highest bid amount is greater than the reserve price, in step 1175, the SSP 906 then forwards the ad (or the indicia of the ad, such as an ad tag) to the client 912B to be displayed to the user. If the highest bid amount is lower than the reserve price, in step 1170, the SSP 906 then notifies another ad network or an ad exchange of the impression generation, allowing the ad network or ad exchange to identify an ad that exceeds the reserve price of the publisher 910. In step 1180, the ad network or ad exchange forwards an ad (or the indicia of the ad, such as an ad tag) to the client 912B to be displayed to the user when the reserve price is met.

### Measurement of Effectiveness of Ad Campaign

In the present invention, the impact of an ad campaign (which includes one or more ads displayed to one or more users over a period of time across web pages) on users can be measured using the measured viewable time of each of the one or more ads of the ad campaign that were displayed to the users. One common metric used to measure impact in the marketing industry is the Gross Rating Point (GRP) achievable for an ad campaign through television. An equivalent GRP (eGRP) metric for online advertising that allow marketers (and advertisers) to easily compare and assess the value of an ad campaign and its impact on the users will be very valuable. The following discussion provides a brief background on calculating GRP and how an eGRP can be calculated using the measured viewable time of the various ads of the ad campaign.

As discussed above, GRP is an effectiveness metric used in TV advertising, and takes into consideration the frequency of the ad being broadcasted and the reach of the delivery (defined as the ratio of the total number of viewers to the size of the advertisement's target). GRP can be computed using the below function (12):

$$GRP = 100 \times \frac{r}{R} \times f \qquad ( 12 )$$

where, R is the total number of latent targets for the ad, r is the realized number of viewers who are targets, and f is the frequency of the delivery.

In an embodiments, when the viewable time for the ads served to the users can be measured (at least for a material subset), the notion of viewable time can be incorporated into GRP and used to calculate it for web content c (such as web pages) using function (13) shown below:

$$GRP 100 \times \frac{{\sum }_{u ∈ U c} ( {\sum }_{v ∈ Vu} r ( {t}_{v} ) )}{{R}_{c}} \qquad ( 13 )$$

where R_{c} is the number of latent targets for content c, Vᵤ is the set consisting of time of deliveries of content c to user u, tᵥ is the length of engagement (viewable time) when user u is viewing content c in opportunity v, and r(tᵥ) is the (normalized) effect of the content when it is viewed until time t. Here, 0<r(tᵥ)<1 (i.e. a weight).

In embodiments, the r(tᵥ) can be determined as a function of whether a given display of a given ad incurred CPV cost (i.e., the given ad was viewed by a given user for at least a predefined viewable time). In one instance, r(tᵥ) can be set as r(tᵥ)=1_{(tv>=LCPV)}, where r(tᵥ) is set to 1 if tᵥ>=L_{CPV} holds true and 0 otherwise, further where L_{CPV} is the least amount of viewable time (i.e. the predefined viewable time) to be achieved before a CPV cost can be charged for the delivery of a given ad in the CPV model. In embodiments, when an advertiser uses a TV advertisement of length L_{TV} as online advertisement and cost is incurred when a portion of the online advertisement is viewed-through (i.e. achieves the L_{CPV}), then L_{CPV}=f(L_{TV}). In embodiments, when an advertiser uses a TV advertisement of length L_{TV} as online advertisement and cost is incurred only when the whole ad is viewed-through (i.e. achieves the L_{CPV}), then L_{CPV}=L_{TV}.

In addition, the modified version of the GRP metric can be compared to GRP metric of TV advertising. In embodiments, the modified version effective GRP (eGRP) can be derived using the function (14) shown below:

$$eGRP = 100 \times \frac{{\sum }_{m ∈ M} {\sum }_{u ∈ {U}_{m}} {\sum }_{v ∈ Vu} w ( m , u ) r ( {t}_{v} )}{R ( M )} \qquad ( 14 )$$

where, M is the set of media to which the content (e.g., an ad, an advertiser owned web page, etc.) is delivered, Uₘ is the set of users who visited medium m, Vᵤ is the set consisting of measured viewable time for each delivery of a corresponding content delivered to user u, and R(M) is the total reach of M.

Further, w(m, u) is a function of (m, u) and its value determines the weight of (m, u). Since online advertising is different from TV advertising, the true effect of online advertising on the users is augmented accordingly. In one embodiment, by setting w(m, u)=1 (a weight to augment the true impact of online ad campaign), the value of online ad delivery is considered to be the same as that of TV ad campaign. On the other hand, by setting w(m, u)=0 when user u visited web page m through clicking an online ad, at least a portion of overestimation of the size of the advertisement's reach (i.e. by not double counting a user's viewing of an ad and an associated web page arrived through the ad) can be avoided.

In embodiments, w(m, u) is determined as a function of the ratio of the sum of area of ad slots which deliver ads to a user to the area of the user's browser. In embodiments, w(m, u) is determined as a function of the ratio of the sum of visible area of ad slots which deliver ads to a user to the visible area of the user's browser. Such a determined w(m, u) corresponds to the idea that one delivery of an online ad has less value than one delivery of a TV ad, where the ad on TV occupies most of the display area.

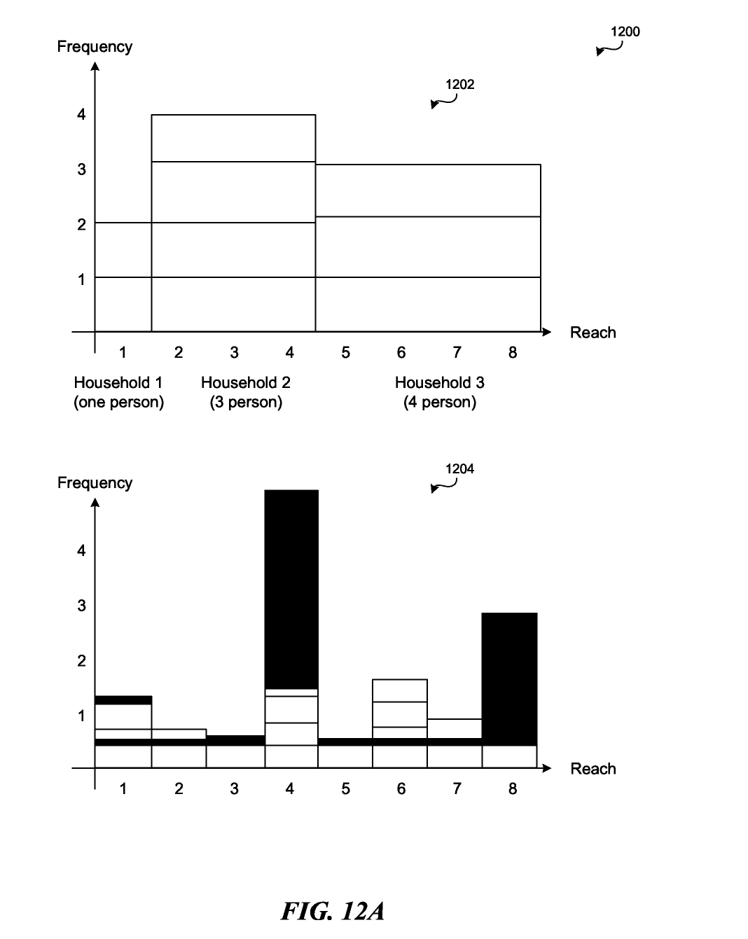

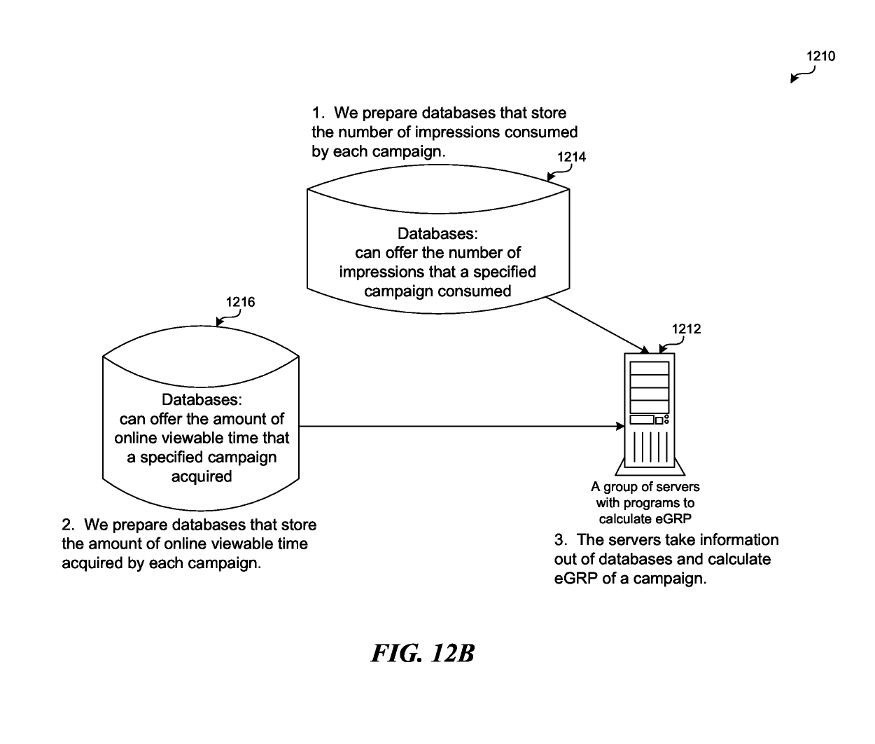

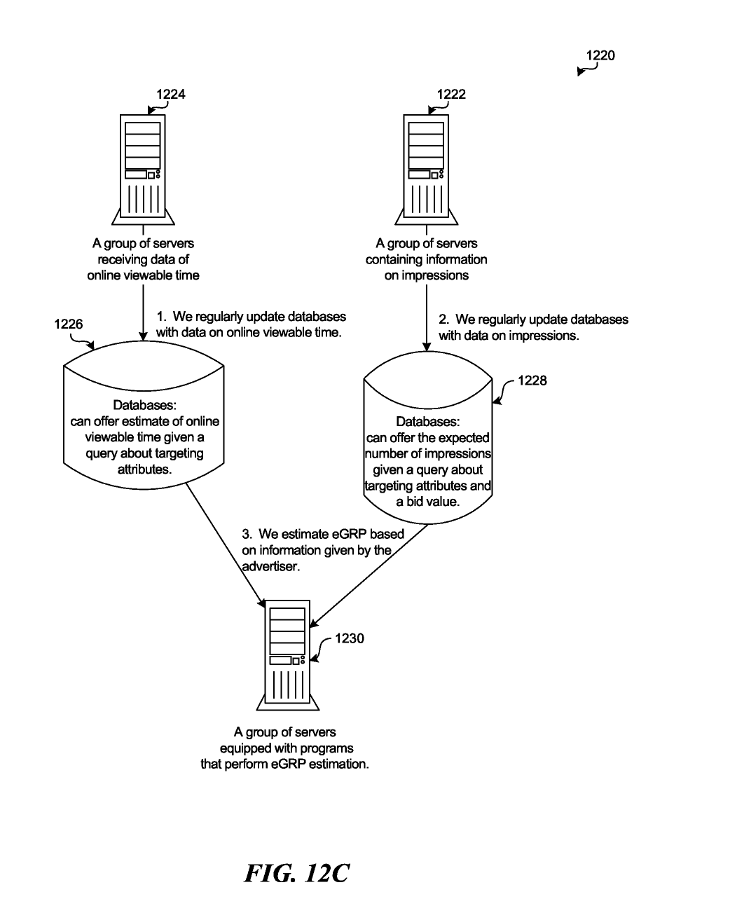

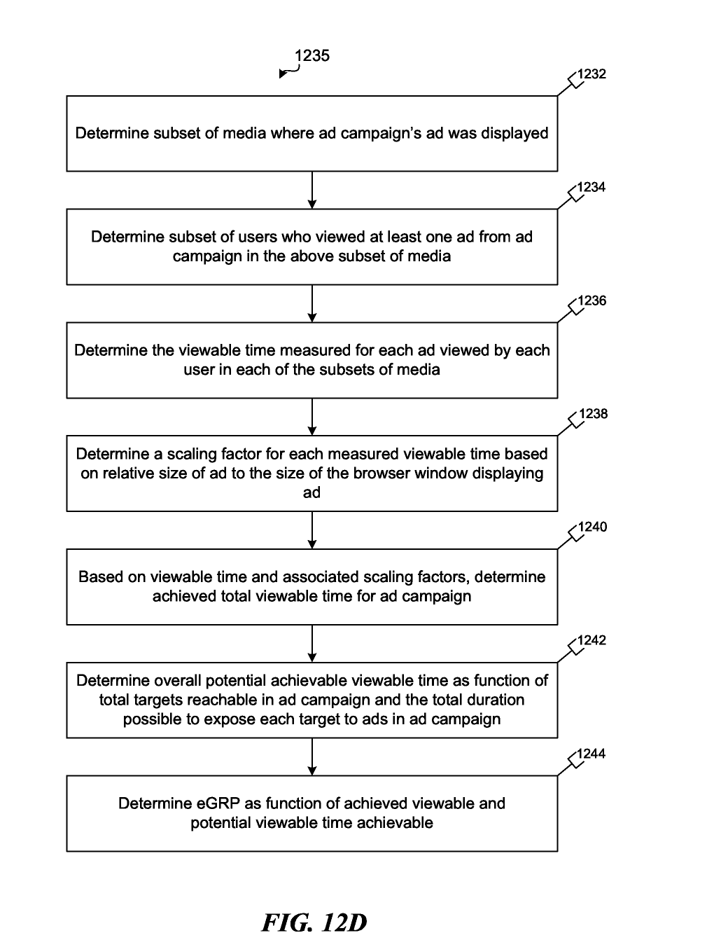

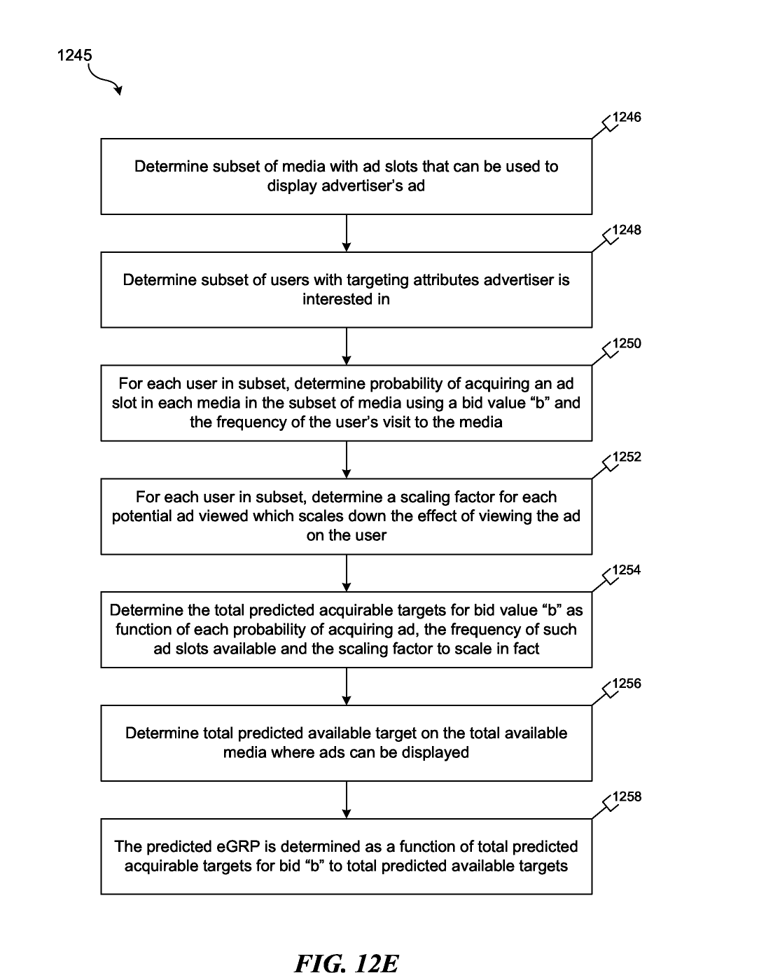

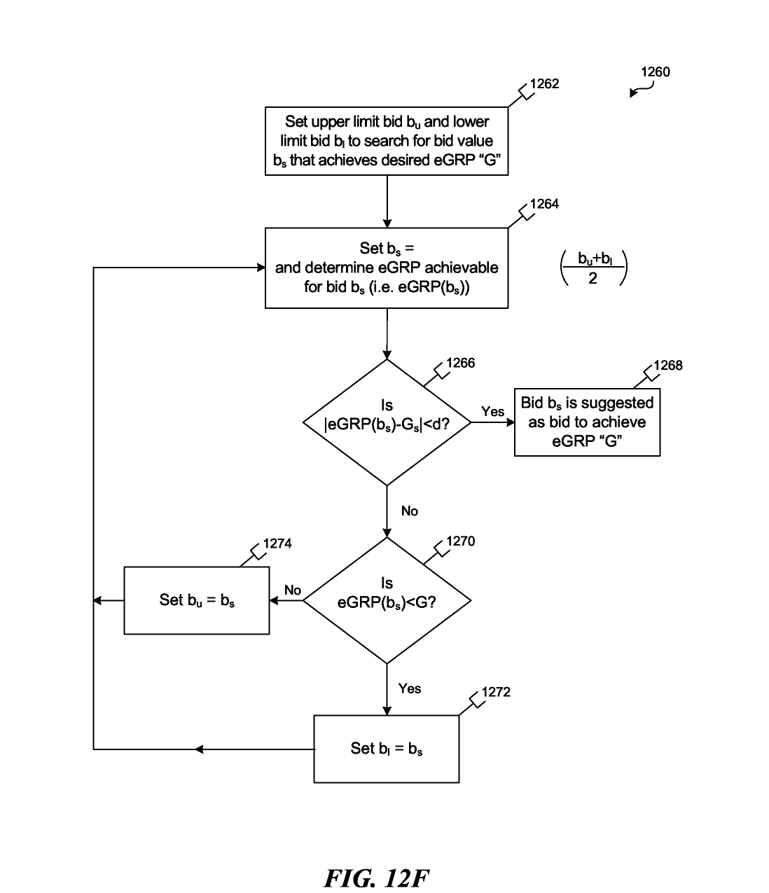

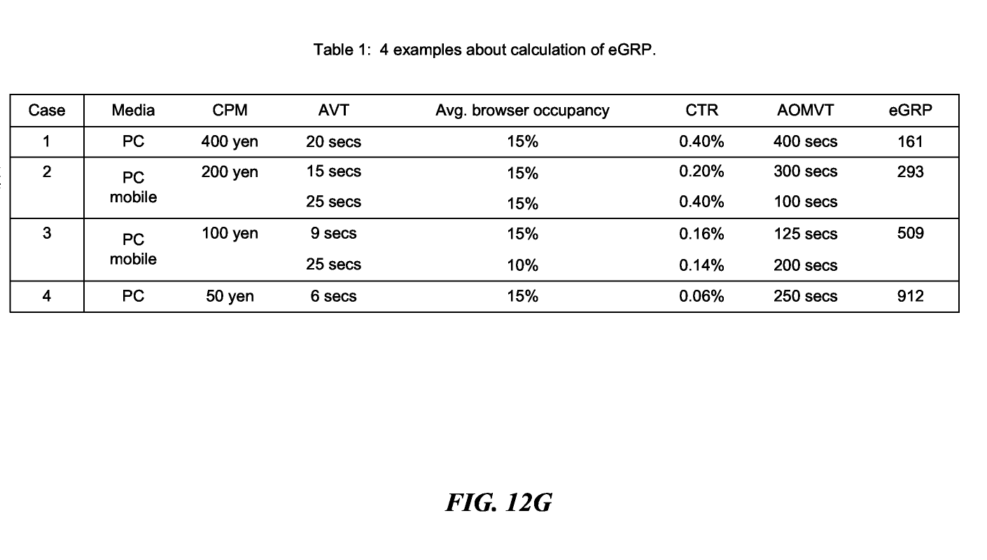

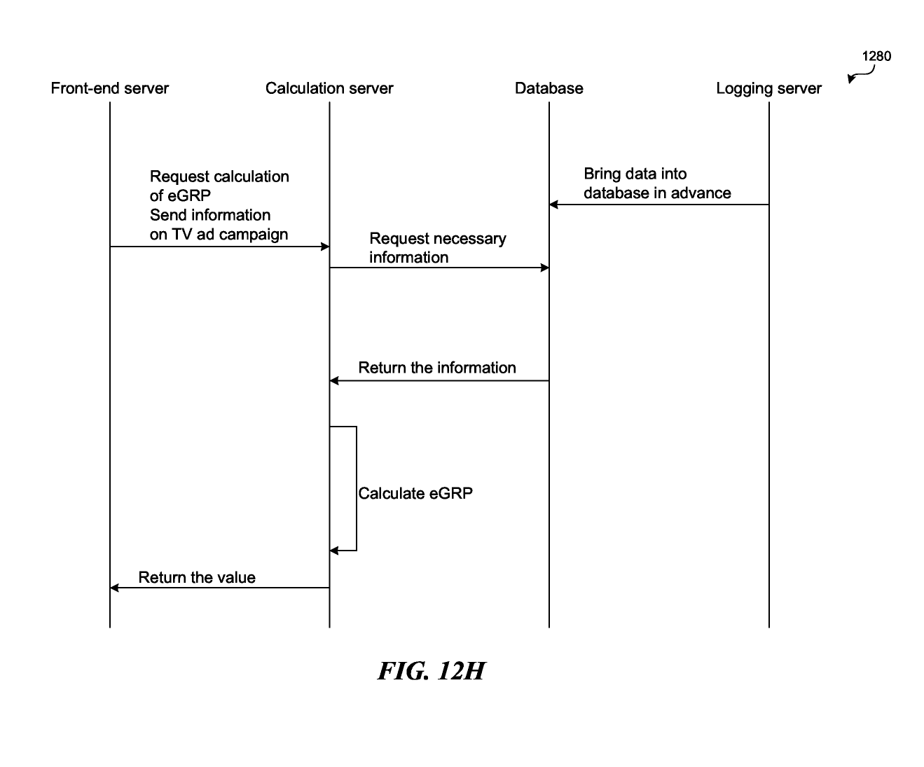

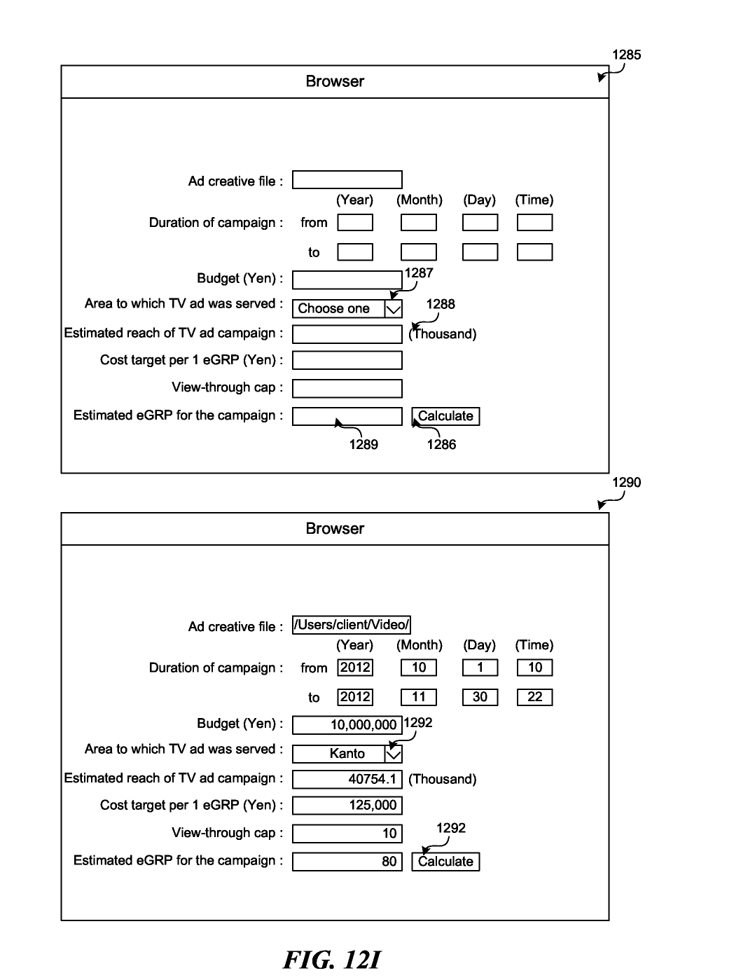

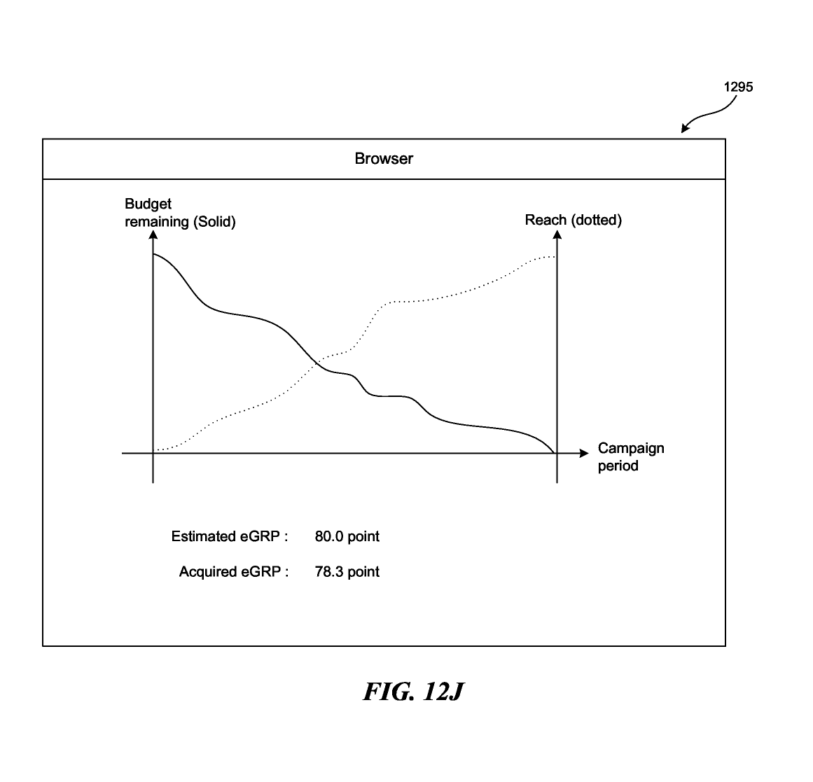

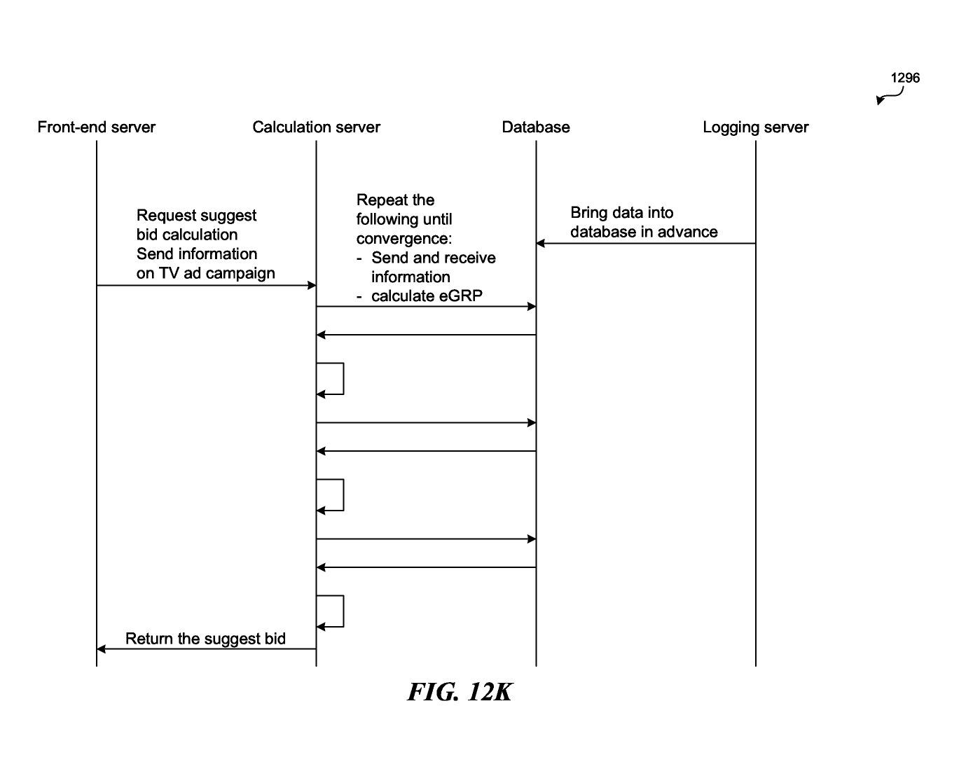

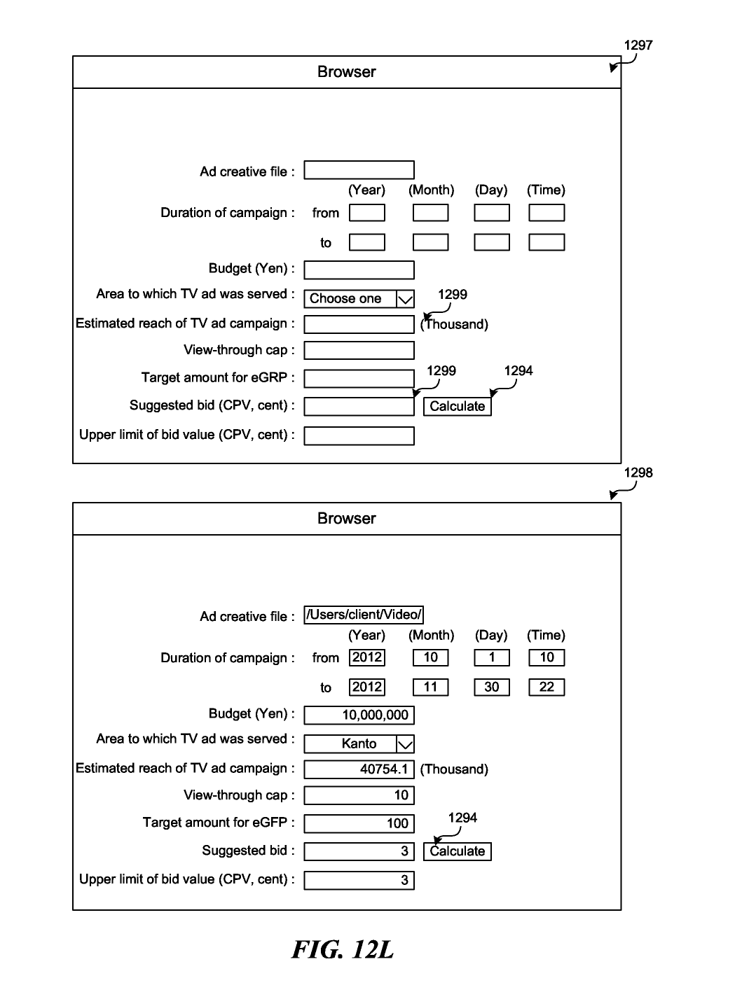

In embodiments, where w(m, u)=1 (online ad delivery equal to an ad delivery through TV) and r(tᵥ)=1 (as discussed above), the estimated eGRP has the following strengths: (1) the eGRP increases only when the ad is viewed-through, where, similar to video advertising, such as TV advertisements, the ad's intended goal is most likely achieved only when it is viewed-through; and (2) the eGRP and GRP of the TV ad campaign will be directly comparable (the number of CPV incurrence and the reach of the TV ad respectively) when the same (or similar) ad creative is used in both TV and online campaigns. Employing eGRP metric enables easy comparison to GRP, facilitating mass marketing including online advertising as part of one unified marketing strategy. FIG. 12A, discussed below, provides a visual representation of the comparison between eGRP and GRP of an ad campaign.

Further, for a given bid value (based of any of the pricing models discussed earlier), an achievable eGRP can be estimated. In embodiments, the eGRP achievable for a CPXs based bid of “b” value from an advertise can the determined using function (15) as shown below:

$$eGRP = 100 \times \frac{{\sum }_{m ∈ M ( T )} {\sum }_{u ∈ {U}_{m} ( T )} w ( m , u ) W ( m , u , b ) {f}_{m} ( u ) \hat{r} ( m , u )}{R ( M ( T ) )} \qquad ( 15 )$$

where, T is the content's targeting attribute, and M(T) and Uₘ(T) are the set of media and users with the specified attributes T respectively. Further, W(u, m, b) is the probability of winning an impression with attribute (m, u) by means of bid value “b”, and fₘ(u) is the estimated number of times user u visits m, and 0<=r̂((m, u)<=1 is the estimated effect of one ad delivery to (m, u) (i.e. the effect of online media m on user u). By plugging in the reach of the TV advertising campaign into R(M(T)), the GRP of TV advertising can be compared with that of online advertising eGRP.

Estimation of eGRP for a Given Ad Campaign

In calculating eGRP for a campaign C, the actual form of w and r need to be specified. The function (15) used to calculate eGRP shows that we can calculate it by giving the estimated size of reach R(M) of M. Further, the effective reach rₑ(m, u, v)=w(m, u)·r(tv) obtained through visit v by user u at medium m. Also, the reach R_{TV} of TV advertising can be utilized as R(M) when comparing the reach of TV advertising to online advertising. Here, the reach of TV advertising includes but not limited to: (1) the number of households which have a chance to be exposed to the TV ad; and (2) the number of people who have a chance to be exposed to the TV ad estimated from the above estimated number of households.

In addition, let tv=L_{TV} for r(tv), where L_{TV} is the length of TV advertisement. Here, both R_{TV} and L_{TV} are given by the advertiser of campaign C. Finally, w(m; u) is set as the ratio of the sum of area of ad slots which deliver ads concerning C to the area of the user's browser (effectively capturing the divided attention of the user in proportion to the relative display area of ad content). Further, r(tv) can be restricted to value less than 1 (to ensure conservative estimate of ad campaign's impact), but may permit the violation of this condition (say, r(tv)=1 when r(tv)>1, if necessary). Utilizing the above described assumptions and values, in one instance, the following method can be utilized to determine eGRP. In the method, for a user u who visits a web page m, the ads of campaign C are delivered in ad slots (also referred to as frames) {fₘⱼ}ⱼ₌₁^{k}.

Here, let S_{b}(t) be the visible area of the user's browser to the user at time t. Further, let S(t) be the sum of area of ad frames {fₘⱼ}ⱼ₌₁^{k} visible at time t. Also, let S be the average size of S(t) over time interval (t; t+i), where i is some constant determined in advance. That is, S can be defined as:

$$S = \frac{1}{i} {\int }_{t}^{t + i} S ( t ) d t \qquad ( 16 )$$

Further, the average visible area is considered since there are rich media which have ad frames that can be expanded by the user's mouse-over on the ad. Here if the averaged time intervals are sufficiently small, then the value of S can be expected to identical to S(t) (muting the averaging process). Similarly, the average of the browser size S_{b}(t) can be calculated and denote as S_{B}. Also, the effective viewable time vₑ(t) at time t=0 is set to 0 (vₑ(0)=0). The vₑ(t) is updated periodically applying the following formula (17):

$${v}_{e} ( t + i ) = {v}_{e} ( t ) + \frac{S}{{S}_{B}} i \qquad ( 17 )$$

Here it is assumed that at least one of {fₘⱼ}ⱼ₌₁^{k} is in viewable state during interval (t; t+i). Further, when the user scrolls past a current displayed ad “m” when measuring viewable time for the displayed ad, the measurement is paused if the ad “m” is outside the visible region of the user's browser. If another ad “mₐ” belonging to the ad campaign enters the visible region of the user's browser, the measurement of viewable time for the new ad in visible region is started as vₑ(mₐ, u, v).

Similarly, when the user moves to owned media mₐ through clicking one of ads delivered to {fₘⱼ}ⱼ₌₁^{k}, the measurement of vₑ(m, u, v) on m is ended and the measurement of vₑ(mₐ, u, v) is started. Also, vₑ(mₐ, u, v) is update based on OMVT (Owned Media Viewable Time as discussed earlier). Since mₐ occupies the whole browser, the effect of OMVT is not weighted lower and vₑ increases at the same rate as OMVT does. The online viewable time vₑ(m, u, v) or vₑ(mₐ, u, v) of u is gathered when u leaves m or mₐ (and ends session). Further, unlike the GRP, the eGRP based purely on viewable time captures the reduced effect of displaying the same ad multiple times to the same user. For example, the viewable time assessed every time a given ad is displayed to the user reduces as the ad is redisplayed to the user and the user pays less and less attention with every redisplay of the ad.

However, in GRP, such repeated displays of an ad are still counted as a complete viewing by the user. That is, the GRP estimated for a TV ad campaign overestimates GRP by counting any viewer (watching or sleeping) in front of TV as having viewed the ad. Further, as discussed above, in online ad, the later delivery of the same ad might have lower viewable time if the user had already seen the ad before.

So, to compensate eGRP and make it comparable to the (overestimated) GRP, we add a factor Pᵣ. L_{TV}. In one embodiment, value Pᵣ·L_{TV} (0<=Pᵣ<=1) is added to viewable time vₑ(m, u, v) for a given ad every time a user watches an ad of campaign C after the first display of the given ad.

For example, if Pᵣ=0.5, it can be interpreted in the following manner: If an ad is delivered twice to a user, one delivery captures the user's attention and the ad is consumed completely; and in the other delivery, the user focuses on other contents than the ad and the advertising effect is possibly proportional to the display time (which can be further weighted according to the relative size of the ad to the browser). So, eGRP using vₑ(m, u, v) obtained above can be defined as shown in following function (18):

$$eGRP = 100 \times \frac{{\sum }_{m ∈ M} {\sum }_{u ∈ {U}_{m}} {\sum }_{v ∈ Vu} ( {v}_{e} ( m , u , v ) + {P}_{r} \cdot {L}_{TV} )}{{R}_{TV} \cdot {L}_{TV}} \qquad ( 18 )$$

That is, eGRP is equal to the total online viewable time acquired divided by the product of the reach of TV advertising and the length of the TV ad (plus the additional point, Pᵣ times the total number of impressions of a given ad). If the ad length of the online ad is same as that of the TV ad, then this metric is a comparison between the reach of the TV ad and the total number of viewers of online ads. Even if the lengths differ, the GRP and eGRP can be compared by multiplying eGRP by some appropriate factor (to scale for the differing lengths). Further, it should be noted that for an ad campaign with multiple ads, in one embodiment, eGRP can be computed using function (18) for each ad of the ad campaign separately and the total sum of the eGRP of all the ads would represent the overall eGRP of the ad campaign.

FIG. 12A provides a comparison 1200 between GRP of TV ad campaign and the eGRP of an online ad campaign. The top graph 1202 illustrates the GRP achieved from the TV ad campaign for a given market, and the bottom graph 1204 illustrates the eGRP achieved from the online ad campaign. The horizontal axis in each graph corresponds to the number of available unique targets (i.e. number of people available in the given market you can be reached by an ad campaign) and the vertical axis represents the effective number of times each person in the available targets are exposed to an ad from the ad campaign. Here, the white boxes denote the contribution that one ad delivery makes to increase of frequency of exposure to the ad. One exposure of a viewer to a TV advertisement increases the frequency of exposure by one, but one exposure to an online advertisement increases it by 0.5 (in FIG. 12A). In graph 1204, the grey boxes indicate the contribution attributed to the length of a user's exposure to the ad to the achieved increase in frequency of exposure to ad. In graph 1204, the black boxes account for the time spent on a site owned by the advertiser. While GRP measures the frequency of exposure on a per household basis, but eGRP measures the reach on a per-person basis.

FIG. 12B provides a general overview of a system 1210 that can be used to estimate the eGRP achieved by an ad campaign. The system 1212 interacts with databases 1214 and 1216 to gather information related to the impressions utilized by the ad campaign to advertise the ad campaign's ads and the viewable time achieved by each displayed ad. As discussed above, the total measured viewable time achieved by the displayed ads and the total viewable time achievable by the ad campaign is used to determine the eGRP of the ad campaign.

FIG. 12C provides a general overview of a system 1220 that can be used to predict an eGRP that can be achieved for a given ad spend. Additional details of such a system and a method used to predict eGRP are provided in later discussions.

FIG. 12D provides an illustrative method 1235 that can be utilized to estimate eGRP achieved by an ad campaign. In step 1232 of the method 1235, a subset of media where the ads of the ad campaign were displayed is selected. In step 1234 of the method 1235, a subset of users who each viewed at least one ad from the ad campaign in the above identified subset of media is selected. This subset of users who were reached through the subset of media represents the total target for exposure to the ad campaign. The portion of this total target that were effectively exposed to the ad campaign (e.g., through the display of an ad associated with the ad campaign) represents the exposure actually achieved by the ad campaign. As discussed earlier, this achieved exposure as a percentage of the total available target is utilized to determine the achieved eGRP of the ad campaign.

In step 1236 of the method 1235, the viewable time measured for each ad viewed by each user (in the subset of users) within the subset of media is determined. For example, by accessing the logging server 908, the viewable time can be determined. In step 1238 of the method 1235, a scaling factor for each measured viewable time in step 1236 is determined. In one embodiment, the scaling factor for a measured viewable time is based on the relative size of the ad (for which the measured viewable time) to the size of the web browser window when displaying the ad to the user. The scaling factor estimates the probable effect of the ad on the user based on the area of displayed ad (relative to the web browser) which was utilized to expose the user to the ad campaign.

In step 1240 of the method 1235, based on the viewable time determined in step 1236 and the associated scaling factor determined in step 1238, the total achieved viewable time for the ad campaign is determined. In one embodiment, the sum of all the measured viewable time determined in step 1236, with each measured viewable time scaled by the associated scaling factor determined in step 1238, determines the total achieved viewable time for the ad campaign. In step 1242 of the method 1235, the overall potential achievable viewable time is determined as a function of total targets reachable in the ad campaign (i.e., the total number of times every user in the subset of users was exposed to an ad from the ad campaign) and the total duration of possible exposure achievable with each exposure of ad (i.e. the total length of ad displayed in the media, irrespective of whether the user viewed it or not) from the ad campaign to the total reachable targets. In step 1244 of the method 1235, the eGRP (a measure of the overall exposure achieved for the ad campaign) is measured as a function of the achieved viewable time and the potential viewable time achievable (i.e. total duration of possible exposure achievable). Equation (14) provides one example of eGRP calculation function.

Prediction of eGRP

As discussed earlier, eGRP can be estimated for a given bid value b of an advertiser. In one embodiment, a bid “b” in the form of CPXs can be converted to achievable eGRP using the following function (15), (19):

$$eGRP = 100 \times \frac{{\sum }_{m ∈ M ( T )} {\sum }_{u ∈ {U}_{m} ( T )} w ( m , u ) W ( m , u , b ) {f}_{m} ( u ) {\hat{r}}_{e} ( m , u )}{R ( M ( T ) )} \qquad ( 19 )$$

where, W, f, \hat{r}ₑ are to be estimated (discussed in detail later). In addition, <u> is a subset of Uₘ which contains users of the same targeting attribute T. <Uₘ> is a partition of Uₘ by <u>, i.e., a collection of <u>. The function (19) can then be redefined as shown below in function (20):

$$eGRP = 100 \times \frac{{\sum }_{m ∈ M} {\sum }_{( u ) ∈ ( {U}_{m} ( T ) 〉} W ( m , 〈 u 〉 , b ) {f}_{m} ( 〈 u 〉 ) ( {\hat{v}}_{e} ( m , 〈 u 〉 ) + {P}_{r} \cdot {L}_{TV} )}{{R}_{TV} \cdot {L}_{TV}} \qquad ( 20 )$$

where, (\hat{v}ₑ(m, [symbol] u [symbol] ) is the estimated online viewable time for a user with attribute (m, <u>). In the method, W is calculated using the following process. In the process, divide M(T) into two disjoint parts: M(T)=M′ u Mₐ. Here Mₐ is the set of media which is owned by the advertiser (e.g., webpage associated with the advertiser), and M′ is the other media (e.g., an ad of the advertiser). For each medium m in M′, calculate Win the following way: Estimate the probability W(m, <u>, b) of acquiring an impression of a user with targeting attribute <u> by bidding b. Gather data for the k impressions (with targeting attribute <u>) which were generated from m. The gathered data include information such as (1) the highest bid value {bᵢ}ᵢ₌₁^{k} for each impression k and the binary values {aᵢ}ᵢ₌₁^{k} where aᵢ takes value 1 if the i-th impression was won with bid value bᵢ. In one instance, an RTB that conducts auction of impressions might be a source of such data. Then W can be estimated using function (21) shown below:

$$W ( m , 〈 u 〉 , b ) = \frac{{\sum }_{i = 1}^{k} {1}_{\{ b \geq {b}_{i} \}} \cdot {p ( {b}_{i} )}^{1 - {a}_{i}}}{k} \qquad ( 21 )$$

where, 0<=p(bᵢ)<=1 is some constant that is dependent on bᵢ and 1_{{b≧b}_{ᵢ}} is a function which takes 1 if b>=bᵢ and 0 otherwise. Here, W was calculated for each targeting attribute separately, but averaged over <u>. Further, although it was assumed that databases specifying media and targeting attributes are searched, a similar method can be applied even if the searches are performed only campaign-wise.

For each media m in Mₐ, the product of elements W and fₘ is estimated. The following discussion provides a method for calculating fₘ and \hat{v}ₑ(m, [symbol] u [symbol] ). The estimate is on the basis of vₑ measured for each user in the previous subsection. One technique for estimating fₘ(<u>) is the following: Let D be the length of some period, such as the duration of the campaign under consideration. Further let Uₘ be the set of users who visit site m during a period of length D, and vᵤ be the number of visits by user uε<u>. In embodiments, fₘ(<u>) can then be estimated as:

fₘ( [symbol] u [symbol] )=min{f_{c}, f̅} (22a)

where, f_{c} is the frequency cap for this ad (e.g., the view-through frequency limit for the given ad for the given user) and f̅ can be one of, but not limited to, the average Σ_{uε<u>}vᵤ/|Uₘ| of vᵤ or the median of vᵤ., the mode of vᵤ, or the median of vᵤ. In embodiments, fₘ(<u>)= f̅(22b).

Further, in embodiments, \hat{r}ₑ(m, u) can be estimated as a function of number of impressions generated at the media m and the number of those impressions that displayed ads that achieved view-through as shown in function 22c below:

\hat{r}ₑ(m,u)=N_{L}(m,<u>)/N(m,<u>) (22c)

where, for each pair (m,<u>) of media and users with the targeted attributes, let N(m,<u>) denote the number of impressions generated at m by users <u> with targeting attributes, and let N_{L}(m,<u>) denote the number of impressions with viewable time (for a given ad displayed within the impression) greater than or equal to L_{CPV} (i.e., the predefined viewable time of the given ad to be the achieved for a view-through of the associated ad to be recorded) within the subset of N(m,<u>) impressions above.

In embodiments, fₘ and \hat{r}ₑ(m, u) can be determined as a function of average viewable time measured with respect to subset of users <u> with the targeting attributes. In embodiments, the various parameters of the eGRP prediction function can be estimated based on search of databases specifying media and targeting attributes associated with the specific ad campaign achieved up to that point. In embodiments, the various parameters of the eGRP prediction function can be estimated based on search of media and targeting attributes associated with similar ad campaign, where similarity of ad campaign can be based on parameters such as objective of the ad campaign, budget, targeted audience, nature of ad creative used in campaign, etc.

In embodiments, where the product of fₘ and ê(m, u) happens to be greater than f_{c} (the upper limit for the number of view-through to be reached for a given user), the product of fₘ and \hat{r}ₑ(m, u) can be set to f_{c} when calculating eGRP. Such a substitution enables eGRP to reflect the effect of the view-through frequency limit associated with a given ad when performing ad targeting, and increase the accuracy of the estimating eGRP for a given budget, allowing an advertiser to make a better estimation of the ROI (return on investment) of the ad campaign beforehand. Further, though ads are prone to be delivered to a given user far more frequently in online advertising than in TV advertising, the number of ad serving to a given user in online ad campaign can be constrained by limiting the number of view-through frequency limit for a given ad to that of the number of times the TV ad is likely to be watched by a given user. The eGRP estimated based on such a view-through frequency limit enables the comparison of TV advertising to online advertising as the eGRP estimation captures the wider audience reach of TV advertising and limits the effect of greater frequency of online campaign's reach of the same subset of audience.

Further, \hat{v}ₑ(m, [symbol] u [symbol] ) can be estimated as the weighted average of vₑ(m; u) over uε<u> as shown in function (23) below:

$${\hat{v}}_{e} ( m , 〈 u 〉 ) = {\sum }_{u ∈ 〈 v 〉} \frac{{v}_{u}}{V} {\sum }_{v ∈ {v}_{u}} {v}_{e} ( m , u , v ) \qquad ( 23 )$$

where, V=Σ_{uε(u)}vᵤ is the total number of visits by users belonging to <u>. Further, vᵤ in defined in two meanings: the number of visits of user u or the set of visits of user u. Further, we can derive fₘ and \hat{v}ₑ as averaged with respect to <u>. Further, although it was assumed that databases specifying media and targeting attributes are searched, a similar method can be applied even if the searches are performed only campaign-wise.

Using the above estimated values, the product of W and fₘ corresponding to each mₐ in Mₐ can be estimated using function (24):

$$\begin{matrix}P ( {m}_{a} , 〈 u 〉 , b ) = W ( {m}_{a} , 〈 u 〉 , b ) \cdot {f}_{{m}_{a}} ( 〈 u 〉 ) \\ = {\sum }_{m ∈ {M}^{′}} {c}_{m} W ( m , 〈 u 〉 , b ) \cdot {f}_{m} ( 〈 u 〉 )\end{matrix} \qquad ( 24 )$$

where, cₘ is the click-through rate (CTR) of medium m. The sum is taken over m, where several ads on m are linked to mₐ (i.e. linked to owned media). If the average of each of W, fm and \hat{v}ₑ is taken with respect to <u>, the prediction formula can be defined as shown in function (25):

$$eGRP = 100 \times \frac{\begin{matrix}{\sum }_{m ∈ {M}^{′}} W ( m , b ) ( {v}_{m} + {P}_{r} \cdot {L}_{TV} \cdot {n}_{m} ) + \\ {\sum }_{m ∈ {M}_{a}} P ( m , b ) ( {\hat{v}}_{e} ( m ) + {P}_{r} \cdot {L}_{TV} )\end{matrix}}{{R}_{TV} \cdot {L}_{TV}} \qquad ( 25 )$$

where, vₘ is the predicted total online viewable time of medium m and nₘ is the expected number of impressions generated from medium m.

FIG. 12C provides a general overview of a system 1220 that can be used to predict an eGRP that can be achieved for a given ad spend. The server 1230 predicts the eGRP based on data available through databases 1226, 1228. The database 1226 is maintained by server 1224 that gathers measured viewable time for various ads served across various ad slots in various web pages. Utilizing the gathered data, the database 1226 can be utilized to determine viewable achievable by displaying ads to users of certain targeting attributes in various media with certain targeting attributes (desired by an ad campaign for example). Similarly, database 1228 is maintained by server 1222 that gathers data regarding various impressions (i.e. a given ad display for a given ad slot). Utilizing the gathered data, the database 1228 can be utilized to determine data regarding prior impression such as the bid value the impression was sold for, the attributes associated with the impression, etc. As discussed above, server 1230 can predict eGRP based on the gathered data from database 1226 and 1228.

FIG. 12E provides an illustrative method 1245 that can be utilized to predict possible eGRP that can achieved for an ad campaign based on a given bid amount. In the method 1245, the potential ad slots that can be purchased and utilized to deliver an ad from the ad campaign to one or more targets (i.e. users) is identified. Using the identified ad slots as the basis, then, similar to the method of estimating achieved eGRP in method 1235, a predicted achievable and a predicted achieved overall exposure is used to compute the predicted eGRP that can be achieved for a given bid amount “b”.

In step 1246 of the method 1245, a subset of media where ads of the ad campaign can be displayed are selected. The selection can be based on attributed associated with the media, such as content, nature, demographic appeal, etc., that are desired by the ad campaign. In step 1248 of the method 1245, a subset of users who each viewed at least any ad (associated with any campaign) in the above identified subset of media. In some embodiments, the subset of users can be further filtered to only include that subset of users who have one or more attributes of the viewers the ad campaign desires to reach.

In step 1250 of the method 1245, for each user in the subset of users, determine the probability of acquiring an ad slot in each media of the subset of media using a given bid value “b” (for displaying an ad from the ad campaign) and the frequency of the user's visit to each media of the subset of media. In one embodiment, the probability of acquiring an ad slot in a certain media for a given bid amount can be determined based on the prior selling prices of the ad slot.

In step 1252 of the method 1245, for each user in the subset of users, a scaling factor for each potential ad view that scaled down the effect of the viewed ad on the user (when computing the overall exposure) is determined. In step 1254 of the method 1245, the total predicted achievable target for bid value “b” is determined as a function of the probabilities of acquiring ad slots determined in step 1250, the frequency of ad slots available (based on frequency of user's visit as determined in step 1250), and the scaling factors determined in step 1252. In step 1256 of the method 1245, determine the total predicted available target on the identified available media, where the ads from the ad campaign could have been displayed. In step 1258 of the method 1245, the predicted eGRP (a measure of the predicted overall exposure achievable for the ad campaign for given bid amount “b”) is measured as a function of the total predicted acquirable targets and the total predicted available targets. Equation (15) provides one example of predicted eGRP calculation function.

FIG. 12H provides an illustrative example of the interactions 1280 between the various participants for assessing eGRP in one embodiment of a system used to assess eGRP. One of the participants, say an advertiser, utilizing a computing system, such as a front-end server, requests eGRP calculation (either achieved eGRP for an ongoing ad campaign or an eGRP estimate for a given ad campaign budget). The request includes information of a TV ad campaign, such as ads run on TV, number of spots, GRP achieved, etc., which are to be used in the estimation or prediction of eGRP of online ad campaign. A computing server, executing the methods to estimate and predict eGRP, receives the eGRP assessment request and in turn queries a database storing information associated with online ad campaign to compute the eGRP. The database, interacting with a logging server that tracks the various activities of the users and the performance of the ad campaigns (such as achieved viewable time for served ads, etc.), manages the online ad campaign data in retrievable format. In response to the query, the database returns the various logged data associated with the online ad campaign to the computing server. Using the eGRP estimation and prediction methods discussed earlier, the computing server computes the eGRP for the online ad campaign using the information received from the database and returns the eGRP to the computing system.

FIG. 12I provides an illustrative example of a User Interface (UI), displayed on the computing system, which can be used by advertisers or ad agencies to interact with the computing server to estimate or calculate eGRP. The UI can be used to obtain an estimate of eGRP before starting an ad campaign or the resultant acquired eGRP during or after the ad campaign is over. The UI 1285 illustrates the interface before inputting any information on the online campaign, while the UI 1290 illustrates the interface, displaying various information, after inputting the necessary information and pushing “calculate” button 1286, 1291 in the UI. The grey boxes 1288, 1289 in the UI 1285 are automatically filled after pushing the “calculate” button based on the information given.

In the FIG. 12I, the client (e.g., advertisers or ad agencies) can choose one of the area given in the drop-down menu 1287, 1292. The client can also assemble the page so that the client can choose multiple non-overlapping areas among many possible choices. Further, the non-overlapping areas can be arbitrarily chosen allowing a given territory (e.g., country) to be partitioned into many different sets of non-overlapping areas. For example, when estimating or predicting eGRP for U.S. market, the U.S. market can be partitioned in many ways, such as: (1) state-wise partition, (2) partition according to whether programs of a given TV station can be watched in a given territory, etc.

FIG. 12J provides an illustrative example of a User Interface (UI), displayed on the computing system, which can used by advertisers or ad agencies to interact with the computing server to estimate or calculate eGRP. The UI 1295 provides the eGRP achieved (or predicted) at any given point with reference to the portion of the online ad campaign budget spent.

Bidding in the Form of Cost Per Desired eGRP

As discussed earlier, advertisers can place bid for ads based on desired eGRP. The following discussion provides a method for determining a bid value “b” necessary to achievable a desired eGRP. As shown in function (19), eGRP is generally defined as:

$$eGRP = 100 \times \frac{{\sum }_{m ∈ M ( T )} {\sum }_{u ∈ {U}_{m} ( T )} w ( m , u ) W ( m , u , b ) {f}_{m} ( u ) \hat{r} ( m , u )}{R ( M ( T ) )} \qquad ( 26 )$$

In the above function 26, b is a bid value in the form of CPXs, where W is monotone-increasing function with respect to b (i.e., if we increase b, win rate W stays same or increases regardless of (m, u)). In embodiments, an appropriate eGRP for a given b can be determined by binary-searching eGRP(b) using the following method. In the method, determine a sufficiently large upper limit bᵤ of b. Let bₛ denote the present candidate bid value and let bₗ=0. Further, let G denote eGRP that the advertiser desires. In the method, calculate bₛ=(bₗ+bᵤ)/2 and eGRP(bs). If eGRP(bₛ)<G then we put bₗ:=bs. Otherwise we set bᵤ:=bₛ.

The above step of resetting the bounds are repeated until |eGRP(bₛ)−G|<d holds for predefined d (a tolerance value). The bid value bₛ arrived in the last iteration is the suggested bid value to achieve the desired eGRP, where the last iteration is the step at which the difference between desired and determined GRP is less than the tolerance d. Further, since R_{TV} and L_{TV} are constant in eGRP calculated with function 18, this suggested bid value “b” is the equivalent suggested bid value for achieving a desired online viewable time. Further, if the size of ad frames is not taken into consideration in the prediction of online viewable time, the suggested bid value “b” can be considered to be derived from the desired viewable time obtained from media including the owned media.

In another embodiment, the cost (in CPXs form) per desired eGRP can be derived as shown in function (27):

$$b = \frac{G \times 100}{L \times R} \times 10000 \qquad ( 27 )$$

where, G denote the desired cost per GRP, L the temporal length of the ad to be delivered, R the total reach of all the media conforming to the targeting attribute that the advertiser specified.

FIG. 12F provides a method 1260 that can be utilized to determine the cost for achieving a desired eGRP for an ad campaign. Further, using the method 1260, advertisers (and campaign managers) can bid in the form of desired eGRP, which can then be converted into cost that can be utilized to achieve the desired eGRP. In method 1260, a binary search of the eGRP prediction function (discussed above) is performed till a cost value at which the predicted eGRP value is close to the desired eGRP value is identified. The cost value is then equal to the cost needed to achieve the desired eGRP. In step 1262, an upper and lower limit bid amount (i.e. cost needed to achieve the desired eGRP) is determined and the search for the bid amount that is needed to achieve the desired eGRP is searched within this limit.

In step 1264, the average of the upper and lower limit is taken and the average bid value is used to determine the predicted eGRP achievable for the average bid value. In step 1266, if the desired eGRP and the predicted eGRP differ by less than tolerance value “d”, then, in step 1268, the average bid value is equal to the cost needed to achieve the desired eGRP. If not, in step 1270, determine if predicted eGRP is over achieving (i.e., exceeds desired eGRP) for the average bid value. If it is, then, in step 1274, set the upper limit bid amount to the average bid value and repeat step 1264. If not, then, in step 1272, set the lower limit bid amount to the average bid value and repeat step 1264.

FIG. 12G provides examples of computed eGRP based on various parameters described above. Table 1 shows the considered case and the resultant eGRP, where AVT is short for average viewable time and AOMVT is for average owned media viewable time. Here, the number of TV viewers defines the reach of TV, where the reach of TV is estimated by (the number of viewing households)×(viewers per viewing household). In the following, the number of viewing households is set to 15 million (the number of households in Kanto region), and viewers per viewing household is set to 2.5. Thus the estimated number of TV viewers is 37.5 million. The ad length of the TV ad is set to 15 seconds and cost per GRP of TV advertising is set to 0.1 million yen. Thus the advertiser acquires 1000 GRP in TV advertising (for a 100 million yen budget). The budget of online advertising is 30 million yen. The purchased impressions are equally distributed to each medium. Let Pr be set to 0.5. Here, Pᵣ is not added when a user visits a site owned by the advertiser by click-through and only add Pᵣ only when an ad is delivered to a user.

FIG. 12K provides an illustrative example of the interactions 1296 between the various participants, in one embodiment of a system, for determining the cost for achieving a desired eGRP for an ad campaign. One of the participants, say an advertiser, utilizing a computing system, such as a front-end server, requests calculation of the cost (or a bid amount) for achieving a desired eGRP. The request includes information of a TV ad campaign, such as ads run on TV, number of spots, GRP achieved, etc., which are to be used in the estimation or prediction of eGRP of online ad campaign. A computing server, executing the method 1260 to estimate the cost for achieving the desired eGRP, receives the bid amount assessment request and in turn queries a database storing information associated with online ad campaigns (that are similar or part of the current online ad campaign) to compute the bid amount.

The database, interacting with a logging server that tracks the various activities of the users and the performance of the ad campaigns (such as achieved viewable time for served ads, etc.), manages the online ad campaign data in retrievable format. In response to the query, the database returns the various logged data associated with the online ad campaign to the computing server. Using the cost estimation method 1260, the computing server recursively queries the database and re-computes the eGRP achievable for a given cost till the computed eGRP fall within a range of the desired eGRP. The cost estimated for the computed eGRP is returned to the computing system as the bid amount necessary to achieve the desired eGRP.

FIG. 12L provides an illustrative example of a User Interface (UI), displayed on the computing system, which can be used by advertisers or ad agencies to interact with the computing server to estimate the cost (or bid amount) to achieve a desired eGRP. The UI can be used to obtain an estimate of cost for achieving a desired eGRP before starting an ad campaign. The UI 1297 illustrates the interface before inputting any information on the online campaign, while the UI 1298 illustrates the interface, displaying various information, after inputting the necessary information and pushing “calculate” button 1294 in the UI. The grey boxes 1299 in the UI 1297 are automatically filled after pushing the “calculate” button based on the information given.

In the FIG. 12L, the client (e.g., advertisers or ad agencies) can choose one of the area given in the drop-down menu for “Area to which TV ad was served”. The client can also assemble the page so that the client can choose multiple non-overlapping areas among many possible choices. Further, the non-overlapping areas can be arbitrarily chosen allowing a given territory (e.g., country) to be partitioned into many different sets of non-overlapping areas. For example, when estimating cost for desired eGRP for U.S. market, the U.S. market can be partitioned in many ways (and the cost estimated as sum of cost for each of the partitioned portion), such as: (1) state-wise partition, (2) partition according to whether programs of a given TV station can be watched in a given territory, etc.

### Architecture of Platform Server

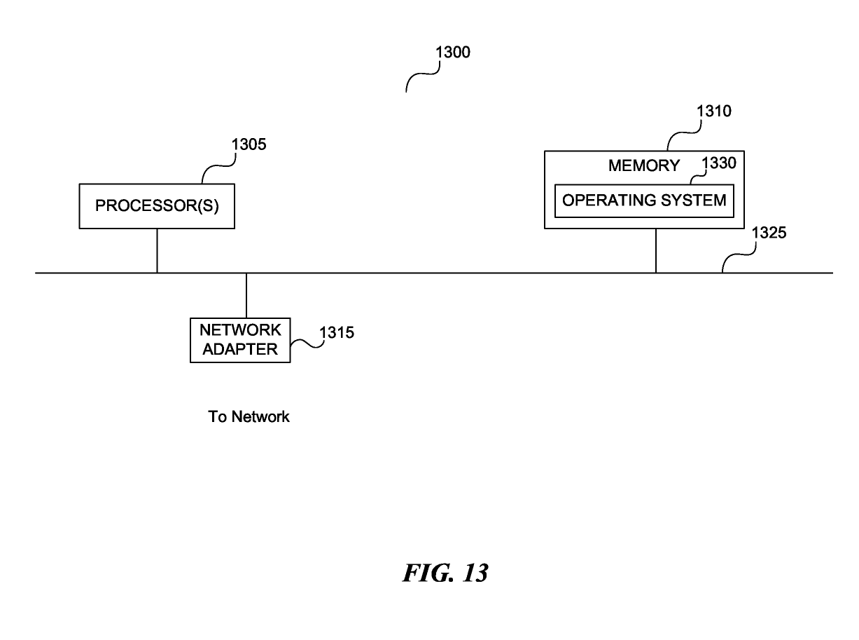

FIG. 13 is a high-level block diagram showing an example of the architecture for a computer system 1300 that can be utilized to implement, for example, a platform server (e.g., 114 from FIG. 1), a web server (e.g., 125 from FIG. 1), or any other computing device identified in the above disclosure. The computer system 1300 includes one or more processors 1305 and memory 1310 connected via an interconnect 1325. The interconnect 1325 is an abstraction that represents any one or more separate physical buses, point to point connections, or both connected by appropriate bridges, adapters, or controllers. The interconnect 1325, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire.”

The processor(s) 1305 may include central processing units (CPUs) to control the overall operation of, for example, the host computer. In certain embodiments, the processor(s) 1305 accomplish this by executing software or firmware stored in memory 1310. The processor(s) 1305 may be, or may include, one or more programmable general-purpose or special-purpose microprocessors, digital signal processors, programmable controllers, application specific integrated circuits (ASICs), programmable logic devices (PLDs), or the like, or a combination of such devices.

The memory 1310 is or includes the main memory of the computer system 1300. The memory 1310 represents any form of random access memory (RAM), read-only memory (ROM), flash memory (as discussed above), or the like, or a combination of such devices. In use, the memory 1310 may contain, among other things, a set of machine instructions which, when executed by processor 1305, causes the processor 1305 to perform operations to implement embodiments of the present invention.

Also connected to the processor(s) 1305 through the interconnect 1325 is a network adapter 1315. The network adapter 1315 provides the computer system 1300 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

1. A method for identifying an advertisement to display in an impression, the method comprising:
identifying, by a platform server having a processor, one or more advertisements from a plurality of advertisements, the identification of a given advertisement from the plurality of advertisements determined as a function of a bid amount associated with the given advertisement and a reserve price associated with the given impression, the reserve price being a suggested bid amount to be paid for a display of the given advertisement in the given impression;
determining, by the platform server, an ad relevancy score for each of the one or more identified advertisements, the ad relevancy score for the given advertisement determined as a function of both the bid amount associated with the given advertisement and a bid amount premium associated with the given advertisement, the ad relevancy score for the given advertisement further determined as a function of a total number of prior display of the given advertisement to a user associated with the impression and a total number of allowed display of the given advertisement to a given user;
sorting, by the platform server, the one or more identified advertisements based on the ad relevancy score associated with each of the one or more identified advertisements; and
identifying, by the platform server, the advertisement to display in the impression from the one or more sorted advertisements, the identified advertisement to display in the impression determined as a function of the ad relevancy score associated with the advertisement.

2. The method of claim 1, wherein a prior display of the given advertisement is determined as a function of both a measured total attention duration of the given user to the display of the given advertisement and a predefined minimum duration of display time associated with the given advertisement, wherein the prior display of the given advertisement is not incurred when the measured total attention duration of the given user is less than the predefined minimum duration of display time.

3. The method of claim 1, wherein the ad relevancy score for the given advertisement is zero when the total number of prior display of the given advertisement to the user associated with the impression is greater than the total number of allowed display of the given advertisement to the given user.

4. The method of claim 2, wherein the total attention duration of the given user to the given advertisement is measured as a function of a duration of time the attention of the given user was focused on the display of the given advertisement, wherein the total attention duration of the user to the displayed advertisement is less than or equal to the predefined display duration of the advertisement.

5. The method of claim 4, wherein the platform server determines the attention of the given user to the given displayed advertisement based on one or more criteria, the one or more criteria including:
a proportion of the given displayed advertisement visible to the given user through a given web browser, wherein the attention of the given user is focused on the given displayed advertisement when the visible proportion of the given displayed advertisement is greater than a minimum predefined threshold;
a proportion of the given web browser, displaying the given advertisement to the given user, visible to the given user; or
an interaction of the given user with the given web browser, the interaction occurring at least once within each of an one or more predetermined time period.

6. The method of claim 5, wherein the given user interaction includes one or more of:
a mouse roll-over over the given advertisement;
a user click of the given advertisement;
a user input of a like of the given advertisement;
a rewinding of the given advertisement;
a pausing of the given advertisement;
a playing of the given advertisement;
a muting of an audio content with the given advertisement; or
an un-muting of the audio content with the given advertisement.

7. The method of claim 1, wherein the bid amount associated with the given advertisement is computed as a function of both a prior bid amount associated with the given advertisement and a success of displaying the given advertisement based on the prior bid amount.

8. The method of claim 1, wherein the bid amount premium is determined as a function of a similarity between one or more inventory attributes associated with the user and one or more inventory attributes associated with the given advertisement.

9. The method of claim 8, wherein the bid amount premium is determined as a probability of achieving a display of the given advertisement to the user, the probability of achieving a display of the given advertisement determined as a function of the similarity between one or more inventory attributes associated with the user and one or more inventory attributes associated with the given advertisement.

10. A method for identifying an advertisement to display in an impression, the method comprising:
determining, by a platform server having a processor, an ad relevancy score for each of a plurality of advertisements, wherein the ad relevancy score for a given advertisement is determined as a function of a total number of prior display of the given advertisement to a user associated with the impression and a total number of allowed display of the given advertisement to a given user; and
identifying, by the platform server, the advertisement to display in the impression from the plurality of advertisements, wherein the identification of the advertisement from the plurality of advertisements to be displayed in the impression is determined as a function of the ad relevancy score associated with the advertisement.

11. The method of claim 10, wherein a prior display of the given advertisement is determined as a function of both a measured total attention duration of the given user to the display of the given advertisement and a predefined minimum duration of display time associated with the given advertisement, wherein the prior display of the given advertisement is not incurred when the measured total attention duration of the given user is less than the predefined minimum duration of display time.

12. The method of claim 10, wherein the ad relevancy score for the given advertisement is zero when the total number of prior display of the given advertisement to the user associated with the impression is greater than the total number of allowed display of the given advertisement to the given user.

13. The method of claim 11, wherein the total attention duration of the given user to the given advertisement is measured as a function of a duration of time the attention of the given user was focused on the display of the given advertisement, wherein the total attention duration of the user to the displayed advertisement is less than or equal to the predefined display duration of the advertisement.

14. The method of claim 13, wherein the platform server determines the attention of the given user to the given displayed advertisement based on one or more criteria, the one or more criteria including:
a proportion of the given displayed advertisement visible to the given user through a given web browser, wherein the attention of the given user is focused on the given displayed advertisement when the visible proportion of the given displayed advertisement is greater than a minimum predefined threshold;
a proportion of the given web browser, displaying the given advertisement to the given user, visible to the given user; or
an interaction of the given user with the given web browser, the interaction occurring at least once within each of an one or more predetermined time period.

15. The method of claim 14, wherein the given user interaction includes one or more of:
a mouse roll-over over the given advertisement;
a user click of the given advertisement;
a user input of a like of the given advertisement;
a rewinding of the given advertisement;
a pausing of the given advertisement;
a playing of the given advertisement;
a muting of an audio content with the given advertisement; or
an un-muting of the audio content with the given advertisement.

16. The method of claim 10, wherein the ad relevancy score for the given advertisement is further determined as a function of both the bid amount associated with the given advertisement and a bid amount premium associated with the given advertisement.

17. The method of claim 16, wherein the bid amount associated with the given advertisement is computed as a function of both a prior bid amount associated with the given advertisement and a success of displaying the given advertisement based on the prior bid amount.

18. The method of claim 16, wherein the bid amount premium is determined as a function of a similarity between one or more inventory attributes associated with the user and one or more inventory attributes associated with the given advertisement.

19. The method of claim 18, wherein the bid amount premium is determined as a probability of achieving a display of the given advertisement to the user, the probability of achieving a display of the given advertisement determined as a function of the similarity between one or more inventory attributes associated with the user and one or more inventory attributes associated with the given advertisement.

20. A system, comprising:
at least one memory storing computer-executable instructions; and
at least one processor configured to access the at least one memory and execute the computer-executable instructions to perform a set of acts, the acts including:
identifying one or more advertisements from a plurality of advertisements, the identification of a given advertisement from the plurality of advertisements determined as a function of a bid amount associated with the given advertisement and a reserve price associated with a given impression, the reserve price being a suggested bid amount to be paid for a display of the given advertisement in the given impression;
determining an ad relevancy score for each of the one or more identified advertisements, the ad relevancy score for the given advertisement determined as a function of both the bid amount associated with the given advertisement and a bid amount premium associated with the given advertisement, the ad relevancy score for the given advertisement further determined as a function of a total number of prior display of the given advertisement to a user associated with the impression and a total number of allowed display of the given advertisement to a given user;
sorting the one or more identified advertisements based on the ad relevancy score associated with each of the one or more identified advertisements; and
identifying an advertisement to display in the impression from the one or more sorted advertisements, the identified advertisement to display in the impression determined as a function of the ad relevancy score associated with the advertisement.

21-79. (canceled)
